(19) United States
(12) Patent Application Publication
(10) Pub. No.: US 2014/0203184 A1
(43) Pub. Date: Jul. 24, 2014

(54) FLUID MEDIUM SENSOR SYSTEM AND METHOD

(71) Applicant: Visualant, Inc., Seattle, WA (US)

(72) Inventors: Peter Kevin Purdy, Seattle, WA (US); Matthew Creedican, Seattle, WA (US); Brian T. Schowengerdt, Seattle, WA (US); Thomas A. Furness, III, Seattle, WA (US)

(73) Assignee: Visualant, Inc., Seattle, WA (US)

(21) Appl. No.: 14/223,716

(22) Filed: Mar. 24, 2014

Related U.S. Application Data
(63) Continuation of application No. PCT/US2012/056135, filed on Sep. 19, 2012.
(60) Provisional application No. 61/538,617, filed on Sep. 23, 2011.

(51) Int. Cl. G01N 1/10; G01N 21/17

(52) U.S. Cl. CPC G01N 1/10; G01N 21/17
USPC 250/393

(57) ABSTRACT

An apparatus employs a plurality of transducers distributed along a cable to sample a medium. Some of the transducers may be operated according to various sequences which specific wavelengths and/or magnitudes of emission of electromagnetic energy. Some of the transducers sample, detect or measure responses of the fluid medium to the emissions. Various other transducers may sample or measure temperature, depth or pressure, and flow characteristics of the fluid medium, and optionally flow characteristics above a surface or above a surface of the fluid medium. Such may allow identification and/or characterization of characteristics of the fluid medium and/or substances (e.g., contaminants for instance petroleum, phytoplankton, red tide microorganisms, nutrients, dissolved oxygen or other gasses). The apparatus may communicate with remote facilities, allowing monitoring, remote control, and/or analysis with or with information from other platforms.

### BACKGROUND

1. Technical Field

This disclosure relates to sensing characteristics of a fluid medium, for instance characteristics of a body of fresh or salt water or some other reservoir of fluid.

2. Description of the Related Art

It may be useful to identify and/or characterize various aspects of a medium, for example a fluid medium such as a body of salt or fresh water or a reservoir such as a tank that holds fluids. Such may be useful in identifying or characterizing naturally occurring phenomena or conditions. Such may also be useful in identifying or characterizing artificially occurring phenomena or conditions.

For example, it may be useful to identify a presence or absence of certain constituents of the medium, as well as characterizing certain aspects (e.g., level, percentage, parts per million) of those constituents. It may be useful to identify a presence or absence of certain substances in the medium, for example contaminants for instance petroleum or petrochemicals, phytoplankton, red tide microorganisms, nutrients, dissolved oxygen or other gasses. The ability to assess or characterize such may allow assessment of a severity of a risk presented by the same, and/or mobilization of resources to address the risk.

Presently, ships or boats may be sent to take water samples, which are then analyzed, typically in a laboratory environment. In many instances, the samples must be returned to land in order to access the laboratory facilities. In other instances, some laboratory facilities may be provided on board the vessel, although such tend to be cost prohibitive, occupy valuable space on the vessel and may not have all of the equipment typically available in a land based facility.

It would be desirable to have the ability to quickly, efficiently, and accurately assess or characterize fluid mediums, such as bodies of water, without the need to return samples or specimens to land based facilities. It would be desirable to have the ability to quickly, efficiently, and accurately assess or characterize fluid mediums, such as fuel tanks, tanks used in food, beverage and/or pharmaceutical preparation, as well as other reservoirs of fluids.

### BRIEF SUMMARY

A sensor system to sample fluid mediums may be summarized as including at least one housing; at least one cable having a proximate portion, a distal portion and at least one sampling portion between the proximate portion and the distal portion; a plurality of sets of transducers distributed at various respective locations spaced along at least the sampling portion of the cable, each of the sets of transducers including a plurality of emitters and at least one sensor, the plurality of emitters of each set of transducers operable to emit electromagnetic radiation at a plurality of wavelengths from the cable toward a portion of a fluid medium being sampled and the at least one sensor responsive to electromagnetic radiation returned from the portion of the fluid medium being sampled; and at least one power storage device housed by the at least one housing and electrically coupled to provide power at least to the plurality of multispectral transducers during use.

For each set of transducers, the emitters may be operable to emit a plurality of narrow bands of electromagnetic energy at a plurality of respective center wavelengths. For each set of transducers, the emitters may be operable to emit a number of narrow bands of electromagnetic energy at a plurality of respective center wavelengths which number is greater than a total number of emitters of the plurality of emitters of the respective set of transducers. The at least one power storage device may be a rechargeable power storage device housed by the at least one housing, and may further include a renewable power generation system operable to generate electrical power from an ambient environment and to recharge the at least one rechargeable power storage device.

The sensor system may further include a controller housed by the at least one housing and communicatively coupled to control operation of the plurality of sets of transducers. The controller may cause the plurality of emitters of a respective set of transducers to emit electromagnetic energy at a respective first sequence of wavelengths at a first time and at a respective second sequence of wavelengths at a second time, the second sequence of wavelengths different than the first sequence of wavelengths. The controller may cause the plurality of emitters of a respective set of transducers to emit electromagnetic energy at a respective first sequence of magnitudes at the first time and at a respective second sequence of magnitudes at the second time, the second sequence of magnitudes different than the first sequence of magnitudes. The controller may be configured to control a level of current supplied to at least some of the emitters of the sets of transducers, to selectively cause each respective emitter to selectively emit at each of at least two separate center frequencies. The controller may be configured to receive from the at least one sensor of at least some of the sets of transducers a signal indicative of electromagnetic energy in an ambient environment which signal is indicative of a response by the fluid medium to ambient electromagnetic energy without emission by the emitters. The controller may be configured to detect a physical characteristic of the fluid medium being sampled based on signals provided from the sensors indicative of at least one characteristic of the sampled fluid medium and at least one reference characteristic of a reference specimen. The controller may be configured to detect a presence or an absence of a substance in the fluid medium being sampled based on signals provided from the sensors indicative of at least one characteristic of a fluid medium being sampled and at least one reference characteristic of a reference specimen. The controller may be configured to detect at least one of a presence or a concentration of a contaminant in the fluid medium being sampled based on signals provided from the sensors indicative of at least one characteristic of a specimen and at least one reference characteristic of a reference specimen.

The proximate portion of the cable may be a proximate end thereof and the distal portion of the cable may be a distal end thereof, and may further include a number of temperature sensors distributed at various respective locations spaced along at least the sampling portion of the cable, the temperature sensors responsive to an ambient water temperature proximate the respective temperature sensor.

The sensor system may further include a wireless transceiver housed by the at least one housing and communicatively coupled to wirelessly transmit from the at least one housing information indicative of data collected by the sensors of the sets of transducers.

The sensor system may further include at least one buoyant member that carries the at least one housing, the at least one cable physically coupleable to the buoyant member at least proximate the proximate portion of the at least one cable with the distal portion thereof spaced relatively from the buoyant member during use of the sensor system.

The sensor system may further include a plurality of additional buoyant members, each of the additional buoyant members having a respective housing, a respective cable having a proximate portion, a distal portion and at least one sampling portion between the proximate portion and the distal portion; the cable physically coupleable to the respective buoyant member at least proximate the proximate portion of the at least one cable with the distal portion thereof spaced relatively from the buoyant member during use of the sensor system, a respective plurality of sets of transducers distributed at various respective locations spaced along at least the sampling portion of the cable, each of the sets of transducers including a plurality of emitters and at least one sensor, the plurality of emitters of each set of transducers operable to emit electromagnetic radiation at a plurality of wavelengths from the respective cable toward the a respective portion of the fluid medium being sampled and the at least one sensor responsive to electromagnetic radiation returned from the respective portion of the fluid medium being sampled, and a respective wireless transceiver carried by the buoyant member and communicatively coupled to wirelessly transmit from the respective buoyant member information indicative of data collected by the sensors. The at least one buoyant member and the plurality of additional buoyant members may be communicatively coupled to form a distributed sensor network.

The sensor system may further include a daisy chain communications path that provides communications with each of the sets of transducers in a sequence along at least the sampling portion of the cable.

The sensor system may further include a plurality of communications paths that provide communications with respective ones of the sets of transducers in parallel.

The proximate portion of the cable may be a proximate end thereof and the distal portion of the cable may be a distal end thereof, and may further include a weight coupled at least proximate the distal end of the cable. The proximate portion of the cable may be a proximate end thereof and the distal portion of the cable may be a distal end thereof, and may further include a sacrificial electrode coupled to provide corrosion resistance to at least one of the cable, the at least one housing or the sets of transducers.

The sensor system may further include at least one depth sensor physically attached to the cable.

The sensor system may further include at least one flow sensor at least indirectly physically coupled to the at least one housing and responsive to provide signals indicative of a fluid flow.

The cable may include at least one fluid conduit extending along at least a portion of a length of the cable and having an interior that provides a path for a fluid, the at least one fluid conduit thermally coupled with at least some of the emitters of at least one of the sets of transducers to exchange heat between the fluid carried in the interior of the fluid conduit and the emitters. At least one fluid conduit may include an opening that fluidly communicatively couples the interior of the fluid conduit with the fluid medium in which the cable is suspended.

The sensor system may further include a pump coupled to cause the fluid to flow in the interior of the at least one fluid conduit, and a controller controllingly coupled to the pump and configured to adjust a flow of the fluid in the interior of the at least one fluid conduit to control a temperature of at least one of the emitters to produce an emission of a defined wavelength.

A method of operating a sensor system may be summarized as including causing a plurality of sets of emitters distributed at various respective locations spaced along at least a sampling portion of a cable suspended in a fluid medium, to respectively emit electromagnetic radiation at a plurality of wavelengths into the fluid medium; and receiving signals from each of a plurality of sensors, the signals indicative of electromagnetic energy returned from the fluid medium at least proximate respective ones of the sensors in response to the emitted electromagnetic radiation.

Causing the plurality of sets of emitters to respectively emit at the plurality of wavelengths may include causing by a controller each of the emitters of at least a first set of emitters to emit at a number of narrow bands of electromagnetic energy at a plurality of respective center wavelengths which number is greater than a total number of emitters in the first set of emitters. Causing the plurality of sets of emitters to respectively emit at the plurality of wavelengths may include causing by a controller each of the emitters of at least a first set of emitters to emit electromagnetic energy at a respective first sequence of wavelengths at a first time and at a respective second sequence of wavelengths at a second time, the second sequence of wavelengths different than the first sequence of wavelengths.

The method of operating a sensor system may further include causing by the controller each of the emitters of the first set of emitters to emit electromagnetic energy at a respective first sequence of magnitudes at the first time and at a respective second sequence of magnitudes at the second time, the second sequence of magnitudes different than the first sequence of magnitudes. Causing the plurality of sets of emitters to respectively emit at the plurality of wavelengths may include causing by the controller a level of current supplied to at least some of the emitters in at least a first set of emitters to be adjusted, to selectively cause each of the at least some of the emitters in at least the first set of emitters to selectively emit at each of at least two separate center frequencies.

The method of operating a sensor system may further include receiving by a controller a signal from at least one of the sensors indicative of electromagnetic energy in an ambient environment which is indicative of a response by the fluid medium to ambient electromagnetic energy without emission by the emitters.

The method of operating a sensor system may further include detecting an ambient temperature of the fluid medium by each a number of temperature sensors distributed at various respective locations spaced along at least the sampling portion of the cable, the temperature sensors responsive to the ambient temperature proximate the respective temperature sensor.

The method of operating a sensor system may further include detecting at least one depth; and logically associating by a controller the detected depth with at least one of the emitters or a measurement produced by at least one of the sensors.

The method of operating a sensor system may further include wirelessly transmitting information from the buoyant member, the information indicative of data collected by the plurality of sensors.

The method of operating a sensor system may further include wirelessly receiving instructions at the sensor system, the instructions indicative of operational characteristics to operate the plurality of emitters.

The method of operating a sensor system may further include providing daisy chain communications with each of the sensors in a sequence along at least the sampling portion of the cable.

The method of operating a sensor system may further include providing parallel communications with respective ones of the sensors in parallel along respective communications paths.

The method of operating a sensor system may further include detecting at least one characteristic of a fluid flow.

The method of operating a sensor system may further include assessing by at least one processor at least one characteristic of the fluid medium based on the signals received from at least some of the sensors and based at least in part on a reference characteristic of a reference medium.

The method of operating a sensor system may further include assessing by at least one processor a concentration of a substance in the fluid medium based on the signals received from at least some of the sensors and based at least in part on a reference characteristic of a reference medium.

The method of operating a sensor system may further include assessing by at least one processor a presence or an absence of a substance in the fluid medium based on the signals received from at least some of the sensors and based at least in part on a reference characteristic of a reference medium.

The method of operating a sensor system may further include assessing a concentration of a contaminant in the fluid medium based on the signals received from at least some of the sensors and based at least in part on a reference characteristic of a reference medium.

The method of operating a sensor system may further include assessing a presence or an absence of a contaminant in the fluid medium based on the signals received from at least some of the sensors and based at least in part on a reference characteristic of a reference medium.

The method of operating a sensor system may further include supplying power to the emitters from at least one rechargeable power storage device.

The method of operating a sensor system may further include generating electrical power from an ambient environment; and recharging the at least one rechargeable power storage device using the generated electrical power.

The method of operating a sensor system may further include positioning the sampling portion of the cable at a first depth at a first time; acquiring samples of the fluid medium at the first depth; positioning the sampling portion of the cable at a second depth at a second time; and acquiring samples of the fluid medium at the second depth.

The cable may include at least one conduit extending along at least a portion of a length thereof and passing at least proximate at least some of the multispectral transducers, the method further including drawing a portion of the fluid medium into the conduit. The cable may include at least one conduit extending along at least a portion of a length thereof and passing at least proximate at least some of the multispectral transducers, the method further including controlling a flow of fluid through the conduit to achieve a desired wavelength of emission of at least one of the multispectral transducers.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an isometric view of a fluid medium sensor apparatus operable to sense characteristics of a fluid medium such as a body of water which employs a buoyant member and cable suspended therefrom and which carries a plurality of transducers, according to one illustrated embodiment.

FIG. 2 is a schematic view of the fluid medium sensor apparatus of FIG. 1.

FIG. 3A is a schematic view of a communicative coupling of the transducers carried by the cable to a control system of the fluid medium sensor apparatus of FIG. 1, according to one illustrated embodiment.

FIG. 3B shows a cross-sectional view of the cable of FIG. 3A, according to one illustrated embodiment.

FIG. 4A is a schematic view of communicative coupling of the transducers to carried by the cable to a control system of the fluid medium sensor apparatus of FIG. 1, according to another illustrated embodiment.

FIG. 4B is a cross-sectional view of the cable of FIG. 4A, according to one illustrated embodiment.

FIG. 5 is a schematic view showing a system including various electrical and electronic components to provide power and communications for the fluid medium sensor apparatus of FIG. 1, according to one illustrated embodiment.

FIG. 6 is a schematic view of a distributed system including three groups of the buoyant members each including respective cable(s) carrying transducers, at least one control facility, at least one satellite that provides communications between the control facility and the buoyant members, and a ship that receives navigational warnings and/or other information from the buoyant members, according to one illustrated embodiment.

FIG. 7 is a flow diagram showing a high level method of operating a fluid medium sensor apparatus to sense characteristics of a fluid medium, for instance a body of water using a plurality of transducers distributed along a cable, according to one illustrated embodiment.

FIG. 8 is a flow diagram showing a low level method of operating a fluid medium sensor apparatus to sense characteristics of a fluid medium, for instance a body of water using a plurality of transducers distributed along a cable, according to one illustrated embodiment, which may be employed as part of the method of FIG. 7.

FIG. 9 is a flow diagram showing a low level method of operating a fluid medium sensor apparatus to sense characteristics of a fluid medium, for instance a body of water using a plurality of transducers distributed along a cable, according to one illustrated embodiment, which may be employed as part of the method of FIG. 7.

FIG. 10 is a flow diagram showing a low level method of operating a fluid medium sensor apparatus to sense characteristics of a fluid medium, for instance a body of water using a plurality of transducers distributed along a cable, according to one illustrated embodiment, which may be employed as part of the method of FIG. 7.

FIG. 11 is a flow diagram showing a low level method of operating a fluid medium sensor apparatus to sense characteristics of a fluid medium, for instance a body of water using a plurality of transducers distributed along a cable, according to one illustrated embodiment, which may be employed as part of the method of FIG. 7.

FIG. 12 is a flow diagram showing a low level method of operating a fluid medium sensor apparatus to sense characteristics of a fluid medium, for instance a body of water using a plurality of transducers distributed along a cable, according to one illustrated embodiment, which may be employed as part of the method of FIG. 7.

FIG. 13 is a flow diagram showing a low level method of operating a fluid medium sensor apparatus to sense characteristics of a fluid medium, for instance a body of water using a plurality of transducers distributed along a cable, according to one illustrated embodiment, which may be employed as part of the method of FIG. 7.

FIG. 14 is a flow diagram showing a low level method of operating a fluid medium sensor apparatus to sense characteristics of a fluid medium, for instance a body of water using a plurality of transducers distributed along a cable, according to one illustrated embodiment, which may be employed as part of the method of FIG. 7.

FIG. 15 is a flow diagram showing a low level method of operating a fluid medium sensor apparatus to sense characteristics of a fluid medium, for instance a body of water using a plurality of transducers distributed along a cable, according to one illustrated embodiment, which may be employed as part of the method of FIG. 7.

FIG. 16 is a flow diagram showing a low level method of operating a fluid medium sensor apparatus to sense characteristics of a fluid medium, for instance a body of water using a plurality of transducers distributed along a cable, according to one illustrated embodiment, which may be employed as part of the method of FIG. 7.

FIG. 17 is a flow diagram showing a low level method of operating a fluid medium sensor apparatus to sense characteristics of a fluid medium, for instance a body of water using a plurality of transducers distributed along a cable, according to one illustrated embodiment, which may be employed as part of the method of FIG. 7.

FIG. 18 is a flow diagram showing a low level method of operating a fluid medium sensor apparatus to sense characteristics of a fluid medium, for instance a body of water using a plurality of transducers distributed along a cable, according to one illustrated embodiment, which may be employed as part of the method of FIG. 7.

FIG. 19 shows a low level method of operating a fluid medium sensor apparatus to sense characteristics of a fluid medium, for instance a body of water using a plurality of transducers distributed along a cable by adjusting temperature, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with wireless communications, position determination, power production including rectification, conversion and/or conditioning, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

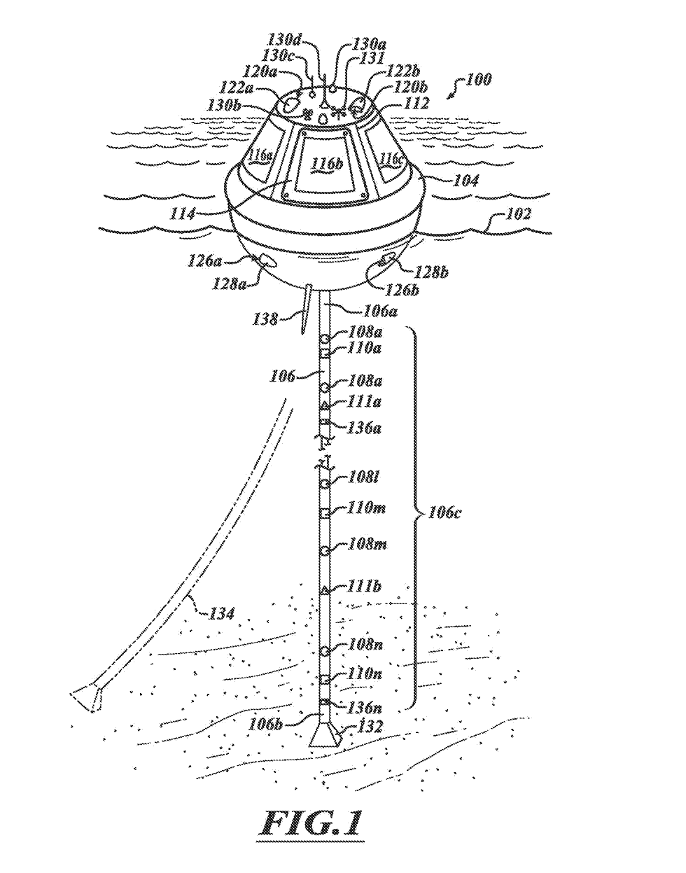

FIG. 1 shows a fluid medium sensor apparatus 100 operable to sense characteristics of a medium 102 for instance a body of fresh water or salt water, according to one illustrated embodiment.

The apparatus 100 may be structured as or include at least one buoyant member 104 that provides sufficient buoyancy such that the apparatus 100 floats above, at or below the surface of the medium 102. Alternatively, the apparatus 100 may omit any buoyant member, being designed for non-floating environments, such as operated off a pier, or used in conjunctions with a tank or other reservoir.

The apparatus 100 includes a cable 106 physically coupled to the buoyant member 104, and a plurality of sets of transducers 108a, 108b, . . . 108l, 108m, 108n (collectively 108, only five shown) distributed at various respective locations spaced along the cable 106 which sets of transducers 108 include transducers that are operable to emit at a number of wavelengths of electromagnetic radiation or energy and transducers to detect or receive responses of the fluid medium to emitted wavelengths of electromagnetic radiation. The electromagnetic radiation will typically be non-ionizing radiation, for instance wavelengths in the optical portion of the electromagnetic spectrum including the visible portion (i.e., Red-Violet) and the non-visible portion thereof (i.e., Infrared (IR), Ultraviolet (UV)).

The apparatus 100 may also include one or more other transducers, for example temperature sensors 110a, . . . 110m, 110n (collectively 110, only three shown) distributed at various respective locations spaced along the cable 106, and operable to provide signals indicative of temperature at least proximate the temperature sensors 110. The apparatus 100 may also include one or more other transducers, for example flow sensors 111a, . . . 111n (collectively 111, only two shown) distributed at various respective locations spaced along the cable 106, and operable to provide signals indicative of at least one of a direction, speed or acceleration of fluid flow (e.g., current) at least proximate the flow sensors 111. Such may be useful in detecting or determining a direction of travel of either the apparatus 100 and/or contaminants in the body of water 102.

The buoyant member 104 may take a variety of forms and houses various components of the apparatus 100, for example the electronics described below. For example, the buoyant member 104 may take the form of an anchored buoy, a free floating buoy, an anchored platform, a free floating platform, an anchored boat or a boat under powered movement. As illustrated, the buoyant member 104 may be a ring buoy, shaped for serviceability. The buoyant member 104 may include one or more sealed compartments. For example, the buoyant member 104 may include one or more sections which may each include a bulkhead or other structure to form a water-tight compartment. Each water-tight compartment may hold air or nitrogen. The buoyant member 104 may include one or more access ports 112 (only one shown) which are accessible via one or more water-tight hatches 114. The access port 112 may provide access to mechanical, electrical and electronic components that may be housed in a hull of the buoyant member 104, for servicing, repair or replacement. In some embodiments, some or all of the mechanical, electrical and electronic components that may be housed in a super-structure that forms an upper portion of the buoyant member 104 or which resides on top of the buoyant member 104.

As noted above, in some instances the apparatus 100 may omit the buoyant member 104. For example, the apparatus 100 may be intended for use off a pier, or for use in a tank, structure or reservoir, or in a mine shaft, the cable being lowered into the fluid medium and secured to some structure with is not floating in the fluid medium.

Where used in a floating environment, it may be advantageous if the apparatus 100 includes at least one source of renewable electrical power. For example, the buoyant member 104 may include a number of photovoltaic (PV) arrays 116a-116d (collectively 116, four illustrated in FIG. 2, only three visible in FIG. 1).

Additionally, or alternatively, the buoyant member 104 may further include one or more ports 120a, 120b (collectively 120, only two shown) which may be surrounded by a wind scoop 122a, 122b (collectively 122, only two shown). Such may capture wind for use in generating electrical power. The ports 120 and wind scoops 122 may be distributed about the buoyant member 104, facing in different directions (e.g., offset by 90 degrees relative to one another) to increase the likelihood that wind will be captured.

Additionally, or alternatively, the buoyant member 104 may further include one or more ports 126a, 126b (collectively 126, only two shown) which may be surrounded by a water scoop 128a, 128b (collectively 128, only two shown). Such may capture water currents for use in generating electrical power. The ports 126 and water scoops 128 may be distributed about the buoyant member 104, facing in different directions (e.g., offset by 90 degrees relative to one another) to increase the likelihood that water currents will be captured.

The apparatus 100 may optionally include one or more navigation warning elements, collectively 130, such as lights (e.g., strobe lights) 130a, bells, whistles, sirens or klaxons 130b, and/or wireless antenna 130c. Such may be advantageous for use in waterborne implementations. The apparatus 100 may optionally include one or more flow sensors 131 to detect a direction and/or speed of a fluid flow, for example an anemometer or other device to detect a direction and speed of air flow above a surface of the body of water 102. Such may be useful in detecting or determining a direction of travel of either the apparatus 100 and/or contaminants in the body of water 102. Again, such may be particularly advantageous for use in waterborne implementations.

The apparatus 100 may optionally include one or more antenna 130d for use, for example, in providing satellite communications, for example with one or more communications satellites and/or global positioning system (GPS) satellites.

In some embodiments, the cable 106 may include a proximate end 106a physically coupled to the buoyant member 104 and a distal end 106b spaced from the buoyant member 104 during use. The proximate end 106a may be removably coupled or fastened to the buoyant member 104 to permit easy and quick replacement, for example if one or more of the multispectral transducers 108 or temperature sensors 110 fail, or should the cable become corroded.

The apparatus 100 may optionally include an anchor 132, which may be removably fastened or coupled at least proximate the distal end 106b of the cable 106. Use of an anchor 132 to secure the buoyant member 104 to the bed or underwater surface of the body of water may advantageously limit the potential for the buoyant member 104 to become a navigational hazard. The anchor 132 may, for example, take the form of a sea anchor or the like. While illustrated as suspended in an essentially straight line, in some instances, the cable 106 may be flexible and currents strong enough relative to a weight of the anchor 132 and cable 106 such that the cable 106 will proscribe a curved or arcuate path 134 in the fluid medium 102.

The distances or positions of the various transducers 108, 110, 111 along the cable 106 may be known. Thus, the depth of those transducers 108, 110, 111 may be known or determinable in conditions where the cable 106 is suspended in at least approximately a straight or vertical line. Where the cable 106 may at times or under certain conditions proscribe a curved or arcuate path 134 in the fluid medium 102, one or more depth transducers 136a, 136n (collectively 136, only two shown) may be advantageously employed to determine the depth of the various transducers 108, 110, 111. The depth transducers 136 may take a variety of forms, for example depth or pressure sensors, for instance a barometric pressure sensors. The depth transducers 136 may be distributed at various respective locations spaced along the cable 106, and operable to provide signals indicative of depth or pressure at least proximate the depth sensors 136. Such may be advantageous for determining a depth of a specific one or more of the multispectral transducers 108, or other transducers, for instance temperature sensor(s) 110, flow sensor(s) 111.

Some embodiments may employ a propulsion system (not shown), for example, an electrical motor that drives a shaft and a propeller or screw. Such may be advantageous for use in waterborne implementations. In some embodiments, the apparatus 100 may advantageously exclude any propulsion system, since such adds unnecessary cost, weight and maintenance issues, and disadvantageously would drain power that could otherwise be used for the reduction reaction. Such may, for example, be used in a free floating implementation.

Where intended for use in sea water, the apparatus 100 may optionally include one or more sacrificial anode structures 138 (only one shown in FIG. 1). The sacrificial anode structure(s) 138 may be formed of a variety of materials that preferentially react (reduce) with salt water relative to the buoyant member, cable, and/or sensors. The sacrificial anode structure 138 may, for example, be formed of cast iron or an alloy of steel. The sacrificial anode structure 138 may be removable from the buoyant member 104 to allow easy removal from and replacement.

FIG. 2 shows one of the multispectral transducers 108 of FIG. 1, according to one illustrated embodiment.

The multispectral transducer 108 includes at least one sensor 202 and a number N of physical emitters or sources 204a-204j (collectively 204), where N is a positive integer. For ease of illustration, FIG. 2 shows ten physical sources (i.e., N=10), however any number of physical sources may be employed.

The physical sources 204a-204j emit electromagnetic energy. Each source of the physical sources 204a-204j may emit electromagnetic energy in a respective band of the electromagnetic spectrum. If the physical sources 204a-204j are driven at the same power level by the driver electronics 111, then in one embodiment, each physical source of the physical sources 204a-204j has an emission spectrum that is different from the emission spectra of the other physical sources 204a-204j. In another embodiment, at least one physical source of the physical sources 204a-204j has an emission spectrum that is different from the emission spectra of the other physical sources 204a-204j. In one embodiment, the physical sources 204a-204j are light emitting diodes (LEDS). In yet another embodiment, the physical sources 204a-204j are tunable lasers. Alternatively, or additionally, the physical sources 204a-204j may take the form of one or more incandescent sources such as conventional or halogen light bulbs. Alternatively, or additionally, the sources 44 may take the form of one or more organic LEDs (OLEDs), which may advantageously be formed on a flexible substrate. Alternatively, or additionally, the physical sources 204a-204j may, for example, take the form of one or more sources of microwave, radio wave or X-ray electromagnetic energy.

One, more or all of the physical sources 204a-204j may be operable to emit in part or all of an “optical” portion of the electromagnetic spectrum, including the visible portion (i.e., portion typically visible to humans without aid), near infrared portion and/or or near ultraviolet portions of the electromagnetic spectrum. Additionally, or alternatively, the physical sources 204a-204j may be operable to emit electromagnetic energy other portions of the electromagnetic spectrum, for example the deep infrared, deep ultraviolet and/or microwave portions of the electromagnetic spectrum.

In some embodiments, at least some of the physical sources 204 are operable to emit in or at a different band than other of the physical sources 204. For example, one or more physical sources 204 may emit in a band centered around 450 nm, while one or more of the physical sources 204 may emit in a band centered around 500 nm, while a further source or sources emit in a band centered around 550 nm. In some embodiments, each physical source 204 emits in a band centered around a respective frequency or wavelength, different than each of the other physical sources 204. Using physical sources 204 with different band centers advantageously maximizes the number of distinct samples that may be captured from a fixed number of physical sources 204. This may be particularly advantageous there is relatively limited space or footprint for the physical sources 204.

Further, the spectral content for each of the physical sources 204 may vary according to a drive level (e.g., current, voltage, duty cycle), temperature, and other environmental factors. Thus, the emission spectra of each of the sources 204 may have at least one of a different center, bandwidth and/or other more complex differences in spectral content, such as those described above (e.g., width of the band, the skew of the distribution, the kurtosis, etc.) from those of the other sources 204. Such variation may be advantageously actively employed to operate one or more of the physical sources 204 as a plurality of “logical sources,” each of the logical sources operable to provide a respective emission spectra from a respective physical source 204. Thus, for example, the center of the band of emission for LEDs may vary according to drive current and/or temperature. One way the spectral content can vary is that the peak wavelength can shift. However, the width of the band, the skew of the distribution, the kurtosis, etc., can also vary. Such variations may be also be advantageously employed to operate at least some of the physical sources 204 as a respective plurality of logical sources. Thus, even if the peak wavelength were to remain constant, the changes in bandwidth, skew, kurtosis, and any other change in the spectrum can provide useful variations in the operation of the multispectral transducers 108. Likewise, the center of the band of emission may be varied for tunable lasers. Varying the center of emission bands for one or more physical sources 204 advantageously maximizes the number of samples that may be captured from a fixed number of physical sources 204. Again, this may be particularly advantageous where the multispectral transducers 108 are relatively small, and has limited space or footprint for the physical sources 204.

A field of emission of one or more physical sources 204 may be movable with respect to a housing. For example, one or more physical sources 204 may be movable mounted with respect to the housing, such as mounted for translation along one or more axes, and/or mounted for rotation or oscillation about one or more axes. Alternatively, or additionally, the test device 102 may include one or more elements operable to deflect or otherwise position the emitted electromagnetic energy. The elements may, for example, include one or more optical elements, for example lens assemblies, mirrors, prisms, diffraction gratings, etc. For example, the optical elements may include an oscillating mirror, rotating polygonal mirror or prism, or MEMS micro-mirror that oscillates about one or more axes. The elements may, for example, include one or more other elements, example permanent magnets or electromagnets such as those associated with cathode ray tubes and/or mass spectrometers. Structures for moving the field of emission and the operation of such are discussed in more detail below.

The sensor 202 can take a variety of forms suitable for sensing or responding to electromagnetic energy returned from the fluid medium being sampled. For example, the sensor 202 may take the form of one or more photodiodes (e.g., germanium photodiodes, silicon photodiodes). Alternatively, or additionally, the sensor 202 may take the form of one or more CMOS image sensors. Alternatively, or additionally, the sensor 202 may take the form of one or more charge couple devices (CCDs). Alternatively, or additionally the sensor 202 may take the form of one or more micro-channel plates. Other forms of electromagnetic sensors may be employed, which are suitable to detect the wavelengths expected to be returned in response to the particular illumination and properties of the material (e.g., fluid, fluid with contaminants such as oil or petroleum product or byproduct) being illuminated.

The sensor 202 may be formed as individual elements, one-dimensional array of elements and/or two-dimensional array of elements. For example, the sensor 202 may be formed by one germanium photodiode and one silicon photodiode, each having differing spectral sensitivities. For example, the multispectral transducers 108 may employ a number of photodiodes with identical spectral sensitivities, with different colored filters (e.g., gel filters, dichroic filters, thin-film filters, etc) over the photodiodes to change their spectral sensitivity. This may provide a simple, low-cost approach for creating a set of sensors with different spectral sensitivities, particularly since germanium photodiodes are currently significantly more expensive that silicon photodiodes. Alternatively, or additionally, the sensor 202 may take the form of one or more photomultiplier tubes. For example, the electromagnetic radiation sensor 202 may be formed from one CCD array (one-dimensional or two-dimensional) and one or more photodiodes (e.g., germanium photodiodes and/or silicon photodiodes). For example, the sensor 202 may be formed as a one- or two-dimensional array of photodiodes. A two-dimensional array of photodiodes enables very fast capture rate (i.e., camera speed) and may be particular suited to use in situations where a speed of the sensor 202 relative to a fluid is particularly high. For example, the sensor 202 may be formed as a one- or two-dimensional array of photomultipliers. Combinations of the above elements may also be employed.

In some embodiments, the sensor 202 may be a broadband sensor sensitive or responsive over a broad band of wavelengths of electromagnetic energy. In some embodiments, the sensor 202 may be a narrowband sensor sensitive or responsive over a narrow band of wavelengths of electromagnetic energy. In some embodiments, the sensor 202 may take the form of several sensor elements, as least some of the sensor elements sensitive or responsive to one narrow band of wavelengths, while other sensor elements are sensitive or responsive to a different narrow band of wavelengths. This approach may advantageously increase the number of samples that may be acquired using a fixed number of sources. In such embodiments the narrow bands may, or may not, overlap.

In some embodiments, the source 204 may also serve as the sensor 202. For example, an LED may be operated to emit electromagnetic energy at one time, and detect returned electromagnetic energy at another time. For example, the LED may be switched from operating as a source to operating as a detector by reverse biasing the LED. Also for example, an LED may be operated to emit electromagnetic energy at one time, and detect returned electromagnetic energy at the same time, for example by forward biasing the LED.

A field of view of the sensor 202 or one or more elements of the sensor 202 may be movable with respect to a housing. For example, one or more elements of the sensor 202 may be movably mounted with respect to the housing, such as mounted for translation along one or more axes, and/or mounted for rotation or oscillation about one or more axes. Alternatively, or additionally, the multispectral transducers 108 may include one or more elements operable to deflect or otherwise position the returned electromagnetic energy. The elements may, for example, include one or more optical elements, for example lens assemblies, mirrors, prisms, diffraction gratings, etc. For example, the optical elements may include an oscillating mirror, rotating polygonal mirror or prism, or MEMS micro-mirror that oscillates about one or more axes. The elements may, for example, include one or more other elements, example permanent magnets or electromagnets such as those associated with cathode ray tubes and/or mass spectrometers.

In some embodiments, the source 204 may also serve as the sensor 202. For example, an LED may be operated to emit electromagnetic energy at one time, and detect returned electromagnetic energy at another time. Also for example, an LED may be operated to emit electromagnetic energy at one time, and detect returned electromagnetic energy at the same time.

The physical sources 204a-204j are mounted on a source end plate 208 and the sensor 202 is mounted on a sensor end plate 210. In another embodiment, the source and sensor end plates 208 and 210, respectively, form a contiguous plate. As illustrated, the physical sources 204a-204j are mounted on the source end plate 208 to form a circle, with the sensor 202 mounted along an axis 212 (orthogonal to the plane of the FIG. 2) that is normal to the source end plate 208 and which passes approximately through a center of the circle. The sensor 202 may be located at any position along the axis 212.

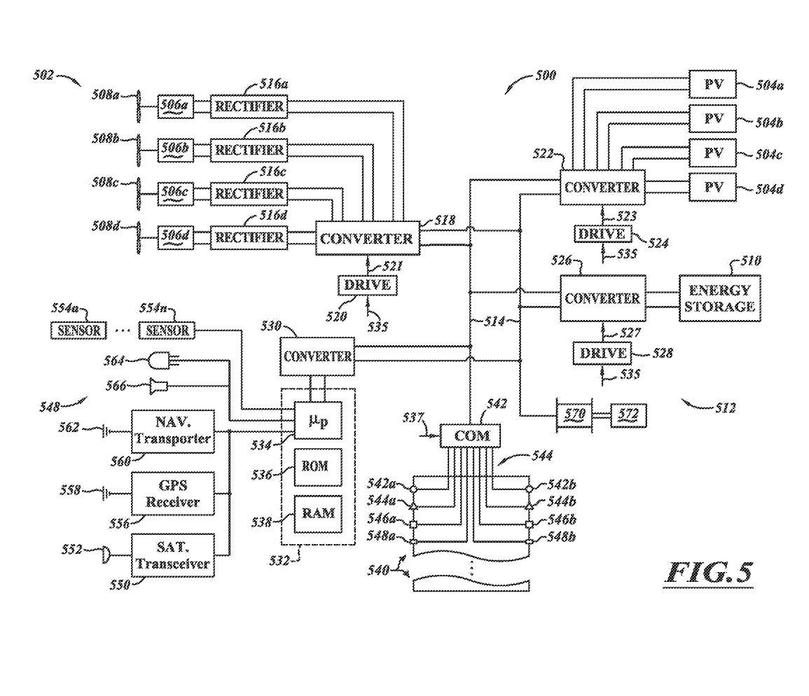

A control system 532 (FIG. 5) drive the physical sources 204a-204j in a selected sequence with an electromagnetic forcing function. A physical source emits electromagnetic energy when driven by the electromagnetic forcing function. In one embodiment, the control system 532 drives the physical sources 204a-204j via the driver electronics (not illustrated). The driver electronics may include any combination of switches, transistors and multiplexers, as known by one of skill in the art or later developed, to drive the physical sources 204a-204j in a selected drive pattern.

The electromagnetic forcing function may be a current, a voltage and/or duty cycle. In one embodiment, a forcing function is a variable current that drives one or more of the physical sources 204a-204j in the selected drive pattern (also referred to as a selected sequence). In one embodiment, the control system 532 (FIG. 5) drives the physical sources 204a-204j (or any subset of the physical sources 204a-204j) in the selected sequence, in which only one or zero physical sources are being driven at any given instant of time. In another embodiment, the control system 532 (FIG. 5) drives two or more physical sources of the physical sources 204a-204j at the same time for an overlapping time period during the selected sequence. The control system 532 may operate automatically, or may be responsive to user input from a user. Use of the electromagnetic forcing function to drive the physical sources 204a-204j as a number of logical sources.

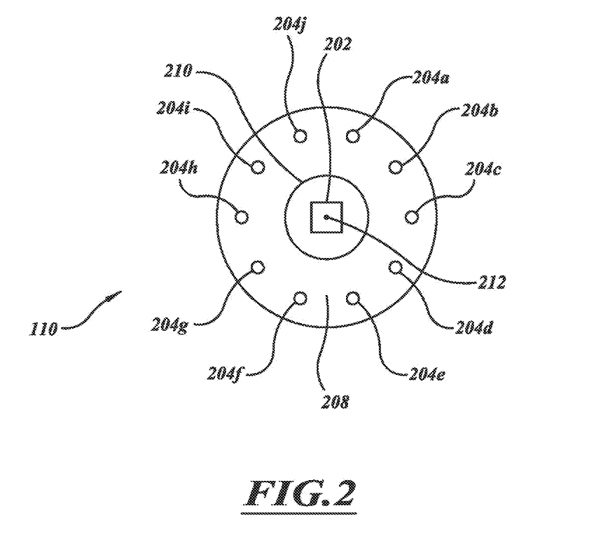

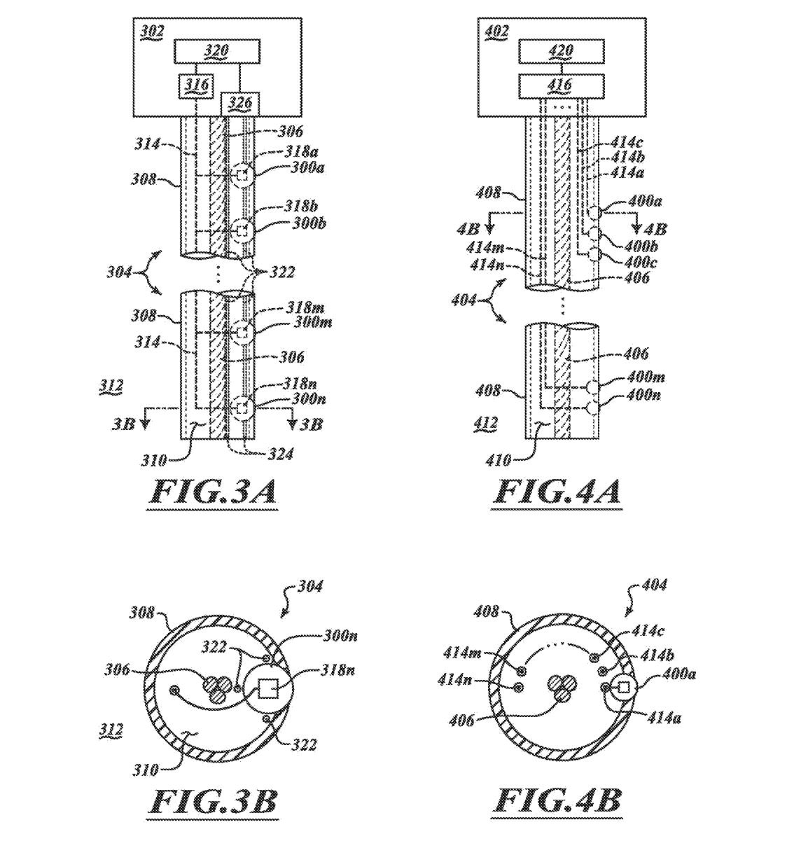

FIGS. 3A and 3B show a communicative coupling of the transducers 300a, 300b, . . . 300m, 300n (collectively 300, only four illustrated in FIG. 3A, one visible in FIG. 3B), to a control system 302 of the apparatus 100 of FIG. 1 via a cable 304, according to one illustrated embodiment.

As explained above, the apparatus 100 (FIG. 1) may include a buoyant member 104 (FIG. 1), and the cable 304 which is suspended from the buoyant member 104 and along which the transducers 300 may be distributed. The cable 304 may, for example include an inner core structural cable 306, for example a braided steel cable which provides strength. The inner core structural cable 306 may be somewhat flexible, particularly over what may be a relatively long length, allowing the inner core structural cable 306 to assume a generally curved or arcuate shape when exposed to certain conditions or forces. While not illustrated in FIG. 3A, an anchor 132 (FIG. 1) may be fixed or detachably coupled at a distal end of the inner core structural cable 306.

The cable 304 may include an outer protective sheath 308. The outer protective sheath 308 may define an interior 310 separate from an exterior 312 by the outer protective sheath 308. The outer protective sheath 308 may provide environmental protection to components or structures in the interior 310. The outer protective sheath may be formed from a large variety of materials. Such materials may, for example, be water proof, and may be corrosion resistant or nonreactive when exposed to corrosive environments such as salt water. The outer protective sheath 308 may be electrically insulative. The outer protective sheath 308 may be somewhat flexible, particularly over what may be a relatively long length, allowing the outer protective sheath 308 to assume a generally curved or arcuate shape when exposed to certain conditions or forces. The cable 304 may include a sacrificial anode structure to prevent or reduce corrosion of the cable 304, particularly the inner core structural cable 306.

A number of communications paths 314 may provide a serial communicative coupling between the transducers 300 and at least one component 316 of the control system 302. The communications paths 314 may, for example, take the form a number or wires or optical fibers. The communications paths 314 may provide a communicative path between a serial bus controller 316 of the control system and respective serial bus transceivers 318a, 318b, . . . 318m, 318n (collectively 318) of the transducers 300. The serial bus controller 316 of the control system 302 may in turn be communicatively coupled to a controller 320 (e.g., microcontroller, microprocessor, application specific integrated circuit, programmable gate array) of the control system 302, for example via one or more buses (e.g., power bus, data bus, instruction bus, address bus).

The cable 304 may also include one or more fluid conduits 322 (three illustrated in FIGS. 3A and 3B). The fluid conduit(s) 322 may extend along all, or a portion of the length of the cable 304. The fluid conduit(s) 322 may be positioned proximate heat generating or producing elements or components (e.g., physical sources or emitters, drive electronics) to allow temperature regulation or cooling of such components. The fluid conduit(s) 322 may, for example include one or more ports, vents or valves 324 to allow and/or control the ingress and egress of fluid. The ports vents or valves 324 may be positioned at a distal end of the fluid conduit(s) 322, at a proximate end of the fluid conduit(s) 322, or at locations therebetween. For example, fluid from the fluid medium being sampled, from the depth being sampled or from some other depth, may be circulated past the components via the fluid conduit(s) 322, transferring heat from the components.

One or more pumps 326 may be employed to actively pump or flow the fluid through the fluid conduit(s) 322, For example, the pump 326 may be coupled to a proximate end of the fluid conduits, with a distal end or other portions of the fluid conduits providing fluid passage from and/or to the body of water, for example via one or more openings and/or valves. The pump 326 may take any of a large variety of forms, for instance positive displacement pumps, rotary pumps, peristaltic pumps, plunger pumps, etc. The pump 326 may be under control of the controller 320, for example in response to temperature measurements from one or more temperature sensors or based on expected temperature calculated or determined based on actual use of the components. Thus, relatively cold water may be drawn from the body of fluid, through the fluid passages to extract heat from the electronics, at a variable rate. Control of temperature realized through control of flow rates may, for example be advantageously employed to control the wavelengths at which sources or emitters emit. Thus, the controller 320 may vary the wavelength of a physical source or emitter, for instance to implement two or more logical sources using a single physical source or emitter. Temperature may be controlled to achieve two or more successive temperatures and hence emission at two or more different wavelengths at respective the temperatures.

Alternatively to use of a pump 325, the fluid conduit(s) 322 may be sized and dimensioned to achieve capillary action to cause flow the fluid therethrough. Such may employ evaporation of fluid to create a vacuum to draw additional water through the fluid conduit or capillary. For example, proximate ends of the fluid conduits or capillaries may be positioned to facilitate evaporation, for example by increasing surface area or by concentrating solar insolation.

FIGS. 4A and 4B show a communicative coupling of the transducers 400a, 400b, 400c, . . . , 400m, 400n (collectively 400, only five shown in FIG. 4A, only one visible in FIG. 4B) to a control system of the apparatus of FIG. 1 via a cable 404, according to another illustrated embodiment.

As explained above, the apparatus 100 (FIG. 1) may include a buoyant member 104 (FIG. 1), and the cable 404 which is suspended from the buoyant member 104 and along which the multispectral transducers 400 may be distributed. The cable 404 may, for example include an inner core structural cable 406, for example a braided steel cable which provides strength. The inner core structural cable 406 may be somewhat flexible, particularly over what may be a relatively long length, allowing the inner core structural cable 406 to assume a generally curved or arcuate shape when exposed to certain conditions or forces. While not illustrated in FIG. 4A, an anchor 132 (FIG. 1) may be fixed or detachably coupled at a distal end of the inner core structural cable 406.

The cable 404 may include an outer protective sheath 408. The outer protective sheath 408 may define an interior 410 separate from an exterior 412 by the outer protective sheath 408. The outer protective sheath 408 may provide environmental protection to components or structures in the interior 410. The outer protective sheath may be formed from a large variety of materials. Such materials may, for example, be water proof, and may be corrosion resistant or nonreactive when exposed to corrosive environments such as salt water. The outer protective sheath 408 may be electrically insulative. The outer protective sheath 408 may be somewhat flexible, particularly over what may be a relatively long length, allowing the outer protective sheath 408 to assume a generally curved or arcuate shape when exposed to certain conditions or forces. The cable 404 may include a sacrificial anode structure to prevent or reduce corrosion of the cable 404, particularly the inner core structural cable 406.

A number of communications paths 414a, 414b, 414c, . . . 414m, 414n (collectively 414, only five illustrated) may provide a parallel communicative coupling between the transducers 400 and at least one component 416 of the control system 402. The communications paths 414 may, for example, take the form a number or wires or optical fibers. The communications paths 414 may provide a communicative path between a parallel bus controller 416 of the control system and the multispectral transducers 400. The parallel bus controller 416 of the control system 402 may in turn be communicatively coupled to a controller 420 (e.g., microcontroller, microprocessor, application specific integrated circuit, programmable gate array) of the control system 402, for example via one or more buses (e.g., power bus, data bus, instruction bus, address bus).

FIG. 5 shows a system 500 operable to provide power, control and communications for the apparatus of FIG. 1 to sense characteristics of a fluid medium such as a body of water 102 (FIG. 1), according to one illustrated embodiment.

The system 500 includes a power subsystem 502 that includes one or more sources of electrical power. The sources of electrical power preferably include sources of renewable electrical power. For example, the power subsystem 502 may include one or more PV arrays 504a-504d configured to produce direct current when illuminated, for example, by solar insolation. The inclusion of two or more PV arrays 504a-504d may provide redundancy. Additionally, or alternatively, the sources of electrical power may include one or more turbines 506a-506d coupled to one or more propellers or blades 508a-508d such that the propellers or blades 508a-508d drive a shaft of the turbines 506a-506d in response to a fluid flow (e.g., air, water) over the propellers or blades 508a-508d. The inclusion of two or more wind turbines may provide redundancy. The turbines 506a-506d and/or propellers or blades 508a-508d may be located in a hull of the buoyant member 16. In at least one embodiment, the propellers or blades 508a-508d are driven by a flow of wind which may be captured and routed to the propellers or blades 508a-508d via one or more ports and/or scoops, for example, ports 120a, 120b and/or scoops 122a, 122d (FIG. 1). In at least one embodiment, the propellers or blades 508a-508d are driven by a flow of water which may be captured and routed to the propellers or blades 508a-508d via one or more ports and/or scoops, for example, ports 126a, 126b and/or scoops 128a, 128d (FIG. 1).

The power subsystem 502 may also include one or more energy storage devices 510 configured to selectively store and release electrical power. The energy storage device 510 may take a variety of forms, for example, one or more rechargeable batteries and/or one or more rechargeable super- or ultra-capacitors.

The power subsystem 502 may include a power supply subsystem 512. The power supply subsystem may include one or more power buses 514 (e.g., 3V, 5V, 12V, 24V, 48V) and one or more rectifiers, alternators, converters or other power conditioning subsystems. For example, the turbines 506a-506d may be coupled to one or more rectifiers 516a-516d to rectify an alternating current (AC) produced by the turbines 506a-506d to a direct current (DC). The rectifiers 516a-516d may take a variety of forms, for example a passive diode bridge or an active rectifier including one or more power transistors (e.g., FET or IGBT). One or more power converters 518 may convert the direct current from the rectifiers 516a-516d, for example, by stepping up or stepping down a voltage to a voltage suitable for the power bus 514. The power converter 518 may take a variety of forms, for example, a passive transformer or an active switch mode converter which includes one or more bridges formed from power transistors. The power converter 518 may, for example, be controlled via gate drive signals (arrow 521) from one or more gate drives 520 to selectively operate the power converter 518 to achieve a desired conversion. In some embodiments, the power converter 518 may also perform rectification in addition to stepping up or stepping down a voltage and/or other power conditioning, eliminating the need for separate rectifiers 516a-516d.

A power converter 522 may convert a direct current (DC) produced by the PV arrays 504a-504d to a form suitable for the power bus 514. The power converter 522 may, for example, take the form of passive device (e.g., transformer) or an active device such as a switch mode power converter operable to step up or step down a voltage of the direct current and/or perform other power conditioning. Where active, the power converter 522 may be controlled via gate drive signals (arrow 523) from a gate drive 524.

A power converter 526 couple direct current between the power bus 514 and the energy storage device 510. The power converter 526 may, for example, step up or step down a voltage of direct current. The power converter 526 may, for example, take the form of a passive device (e.g., transformer) or an active device such as a switch mode power converter. Where active, the power converter 526 may be controlled via gate drive signals (arrow 527) from a gate drive 528.

The power supply system 512 may also include a control system power converter 530 for supplying power at an appropriate voltage to a control system 532. The control system power converter 530 may take the form of a passive device or an active device.

The control system 532 may include one or more processors 534, read only memory (ROM) 536 and/or random access memory (RAM) 538 all coupled by one or more buses, for example, power buses, data buses and/or instruction buses. The memories 536, 538 may store instructions executable by the processor 534 to control operation of the system 500. The processor 534 may take a variety of forms including one or more microprocessors, digital signal processors (DSP), application specific integrated circuits (ASIC) and/or one or more field programmable gate arrays (FPGA). Instructions stored in the memories 536, 538 may be updatable.

The processor 534 may be configured to control operation of the gate drives 520, 524, 528 via one or more control signals represented by arrows 535.

The processor 534 may be configured to control operation of one or more transducers or sensors to collect data or information and/or to process the collected data or information. The processor 534 may communicate with the transducers or sensors via one or more communication paths 544 which are part of a cable 540. For example, the processor 534 may control one or more emitters or sources 542a, 542b (collectively 542, only two illustrated in FIG. 5) to emit electromagnetic energy into a fluid medium at a number of wavelengths and magnitudes, according to various sequences. The processor 534 may receive signals from the sensor(s) 542 indicative of responses (e.g., returned electromagnetic energy) of the fluid medium to the emissions. The processor 534 may analyze the responses, for example comparing such against a number of reference samples at the various emission or excitation wavelengths.

The processor 534 may correlate responses sensed by the sensor(s) with the various wavelengths emitted by the emitters or sources in the particular sequence of emission. The processor 534 may compare the correlated responses to correlated references. For instance, the processor 534 may determine whether a precise match exists over one or more wavelengths, or whether an imprecise match exists over one or more wavelengths, for example within some defined threshold. Thresholds may specify the difference between the sample response to a given wavelength versus a reference response to the given wavelength. Additionally, or alternatively, thresholds may specify the total number or percentage of wavelengths at which precise or imprecise matches need to be found to find an overall match. The comparison of responses correlated to a plurality of wavelengths may advantageously provide a much more detailed spectral signature of the fluid medium being sampled than might otherwise be obtained, allowing a much more refined assessment of the constituents of the fluid medium.

Such may allow the processor 534 to determine a constituent of the fluid medium, for example detecting the presence of one or more substances (e.g., contaminants for instance petroleum, phytoplankton, red tide microorganisms, nutrients, dissolved oxygen or other gasses), or the absence of such, in the fluid medium, and/or a concentration or relative level or concentration of such substances. Also for example, the processor 534 may receive signals from one or more temperature sensors 544a, 544b (collectively 544, only two illustrated in FIG. 5) indicative of temperature at various locations along the cable. The processor 534 may logically associate the samples of electromagnetic radiation responses with the temperature measurements or samples. Such may allow assessment of toxicity, likelihood of growth, and/or assessment of existing and future dispersal of the substances (e.g., contaminants, phytoplankton, red tide microorganisms, nutrients, dissolved oxygen or other gasses). Also for example, the processor 534 may receive signals from one or more flow sensors 546a, 546b (collectively 546, only two illustrated in FIG. 5) indicative a direction, speed and/or acceleration of fluid flow at various locations along the cable. The processor 534 may logically associate the flow measurement with the samples of electromagnetic radiation responses. Such may, for example, allow identification and even accurate prediction of a flow and or dispersal of a contaminant over time. Also for example, the processor 534 may receive signals from one or more depths sensors 548a, 548b (collectively 548, only two illustrated in FIG. 5) indicative a depth or pressure at various locations along the cable. The processor 534 may logically associate the depth measurements with the samples of electromagnetic radiation responses. Such may, for example, allow identification and even accurate prediction of a flow and or dispersal of a contaminant over time in three dimensions. The processor 534 may additionally, or alternatively, control respective ones of the emitters or sources based at least in part on a depth at which the respective emitters or sources are positioned during use, for example accounting for diminishing background light as depth below the surface increases.

The processor 534 can provide one or more control signals 537 to the transducers or sensors via a communications controller or multiplexer 542 to selectively apply signals or receive signals therefrom. As explained above, the processor 534 may employ serial or parallel communications.

The system 500 may include a communication subsystem 548. The communication subsystem 548 may include one or components operable to provide communications from, to, or between the apparatus 100 (FIG. 1) and a remotely located device. For example, the communication subsystem 548 may include one or more satellite transceivers 550 and one or more associated antennas 552 operable to provide communications with a remote site or facility via one or more satellites.

The communications may include transmitting data collected at the apparatus that may be indicative of one or more operational characteristics of the system 500 and/or physical characteristics of the fluid medium 102 such as a body of water. For example, the data may be indicative of an operational characteristic of the sets of transducers 108. For instance, the data may be indicative of one or more sequences of wavelengths and/or magnitudes of emission of electromagnetic energy, and/or measured or detected responses thereto.

The data may be indicative of power production and/or condition of the power storage device or other operational aspect of the system or various subsystems.

While discussed above in terms of the satellite transceiver 550, such data may alternatively or additionally be used by the processor 534 for locally controlling the various transducers or sensors 542, 544, 546, 548. In some embodiments, the processor 534 performs local control based on a first level of feedback while a remote facility performs remote control based on a second level of feedback.

The communication system 548 may also include a GPS receiver 556 and associated antenna 558. Such may be used to determine a precise global location of the apparatus 100 (FIG. 1). Such may be useful where the apparatus 10 is free floating. Such may also be useful where the apparatus 10 is anchored, since the precise position of the apparatus 10 will vary significantly even when anchored. For example, the length of the cable 540 (FIG. 1) may be very long in many applications, allowing significant drift of the apparatus 100 based on tides, waves and/or wind. Location information derived via the GPS receiver 556 may be used by the processor 534 and/or may be relayed to remote sites or to passing ships.

The communications system 548 may further include one or more navigational transponders 560 and associated antennas 562. The navigational transponders 560 and antenna 562 may provide a wireless signal within a relatively limited range of the apparatus 10 to notify shipping of the presence of the apparatus 100 (FIG. 1) which may otherwise be considered a navigational hazard. While illustrated as being coupled to the processor 534, the navigation transponder 560 may be independent of the processor 534, simply deriving power from the power system 512, but otherwise uncontrolled by the processor 534. Additionally, or alternatively, the communication subsystem 548 may include one or more light sources 564 and/or speakers 566 to provide a localized warning of the presence of the apparatus 100 (FIG. 1) to shipping.

The system 500 may include one or more sensors 554a, . . . 554n (collectively 554, only two shown) operable or configured to detect one or more operational aspects of the apparatus 100 (FIG. 1), the system, various subsystems and/or the ambient environment. For example, one or more sensors may detect or measure an amount of power production and/or a condition of the power storage device. One or more sensors 554 may detect or measure other operational aspects of the system or various subsystems, for example communications. One or more sensors 554 may detect or measure an integrity of the buoyant structure.

The system 500 may include an automated cable feed subsystem, including a winch including a reel 570 and motor 572, operable to automatically deploy and recover the cable 540, for example under control of the control system 532.

FIG. 1 illustrates sets of transducers 108, temperature sensors 110, flow sensors 111 and depth transducers 136 as distributed spaced along a sampling portion 106c that extends substantially along the entire length of the cable 106, from the proximate end 106a to the distal end 106b. It is recognized that the sampling portion 106c may constitute only a portion of the length of the cable 106, and the sets of transducers 108, temperature sensors 110, flow sensors 111 and/or depth transducers 136 may be distributed along one or more smaller sampling portions 106c of the cable 106. For example, a cable 106 may have a number of sets of transducers 108 distributed along a sampling portion that is only a relatively small percentage (e.g., less than 50%) of the entire length of the cable 106. Such a cable 106 may be lowered via the reel 570 (FIG. 5) via the motor 572 (FIG. 5) to a first depth at a first time, then to a second or even more depths at subsequent times to obtain samples a different depths. Thus, a relatively small number of transducers spaced along a sampling portion 106c of the cable 106 may be used to sample fluid at different depths. Such may advantageously reduce the cost of the cable 106 since less transducers are required. It is further recognized that any given cable 106 may include two or more sampling portions 106c bearing one or more sets of transducers 108, which other portions spaced in between successively adjacent sampling portions 106c omit transducers. It is noted that the sampling portion(s) 106c may be positioned anywhere along the cable 106. Positioning the sampling portion(s) 106 close to the distal end may advantageously reduce the amount of cable 106 which needs to be handled when sampling at any given depth.

The sets of transducers 108 (FIG. 1) and/or individual transducers (sensors 554, sources 564) may be spaced in fixed increments with respect to one another. Thus, a sampling profile of a defined resolution substantially equal to the distance between successively adjacent (i.e., nearest neighbor) sets of transducers 108, sensors 554 and/or emitters 564 may be established along a depth by sampling using each sensor 554. Advantageously, higher resolution sampling profiles may be obtained using the same cable structure and same spacing between successive ones of the sets of transducers 108, sensors 554 and/or emitters 564 by incrementally moving the cable as samples are captured. For example, the control system 532 may operate a reel 570 and/or motor 572 in synchronization with activation of sources or emitters and capture of returning electromagnetic radiation by sensors to achieve almost any resolution desired. For instance, the sets of transducers 108, sensors 554 and/or emitters 564 may be spaced apart from one another by 1 meter. The cable may be moved in 1 decimeter increments, either generally upward or reeled in, or generally downward or reeled out. At each incremental move or step of the cable, samples may be captured by each of the sensor 554. After 10 incremental moves the resolution of the sampling profile would be 10 times that without the movement of the cable. Other size and number of steps of cable movement may be employed, for example 100 steps of 1 centimeter. Additionally, or alternatively, other spacing of the sets of transducers 108, sensors 554 and/or emitters 564 with respect to one another may be employed. A similar approach may additionally, or alternatively, be employed with the temperature sensors 110, flow sensors 111 and/or depth transducers 136.

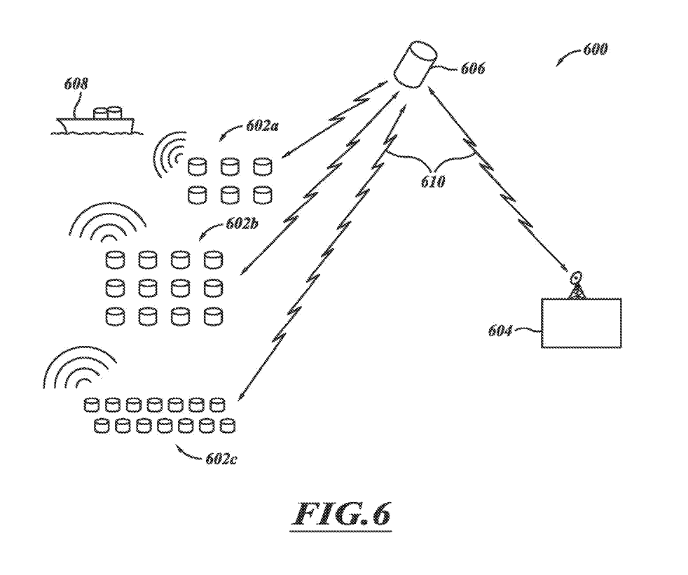

FIG. 6 shows a system 600 including a number of groups or sets of apparatus 602a-602c geographically distributed about an ocean, a remotely located facility 604 to monitor and control operation of the apparatus. a satellite 606 to provide communications between the apparatus and the control facility 604, and also shows a ship 608, according to one illustrated embodiment.

The apparatus may be geographically located in groups or sets 602a-602c of two or more apparatus, geographically distributed about the ocean(s) or seas or other bodies of water, for example worldwide. The inclusion of extra apparatus in a group or set 602a-602c may provide redundancy in case one or more of the apparatus in the group or set 602a-602c fail prematurely. Such may allow sufficient time to repair the failed apparatus without significantly affecting the ability of the group or set of apparatus 602a-602c to collect data over some geographic area. Groups or sets 602a-602c may be precisely scaled to maximize data collection at any given location. The groups or sets 602a-602c may be located in deep water, away from shipping lanes, or in shallow water depending on the application. For example, the groups or sets 602a-602c may be located in or proximate offshore drilling fields where hydrocarbon drilling and/or production occurs. The apparatus in each group or set 602a-602c may be serviced yearly, primarily to maintain the electrical and communications systems. Thus, selected groups or sets 602, or all of the apparatus (e.g., buoyant members) may be distributed about a body of water or portion thereof and communicatively coupled to form a distributed sensor network, for example to measure or otherwise assess a contaminant flow or dispersal across a volume of the body of water The apparatus may communicate directly with one another or may relay communications between one another. Communications may use any of a large variety of techniques and/or protocols, including time division multiple access, frequency division multiple access, code divisional multiple access, spread spectrum, etc. Additionally, or alternatively, the apparatus may communicate with one another via a remotely located “central” communications device, controller, or facility, or may not communicate with one another.

Each apparatus may be autonomously or semi-autonomously controlled, for example based on programmed instructions executed by the respective processor and/or based on a first level of feedback in response to the data produced by the one or more sensors.

The satellite 606 provides communications 610 between the apparatus and one or more remotely located facility 604. The facility 604 may simply receive the communications, allowing monitoring of the operation of the various apparatus and/or resultant data collection. Such may allow computers and/or personnel to assess the operation and/or determine whether maintenance is required. In some embodiments, the facility 604 may provide a remote control of the apparatus, for example based on a second level of feedback based on the data by one or more sensors. Such may include data produced by sensors that are part of the apparatus, and/or other sensors for example sensors carried by aircraft, ships and/or satellites. For example, visual and infrared sensing via satellites or aircraft, as well as measurements from sensors carried by some or all of the apparatus and/or ships, may produce such data. Such may allow precise closed loop control between the collected data and observations from other platforms.

The facility 604 may operate the groups or sets of apparatus 602a-602c based on a larger scale than would otherwise be possible under the autonomous control, accounting for all or many of the deployed apparatus.

One embodiment may employ a purse seine or other retention device to corral a multiple apparatus 100. The purse seine or other retention device may, for example, release the apparatus in response to an emergency condition, such as an oil spill or blow out of a well head.

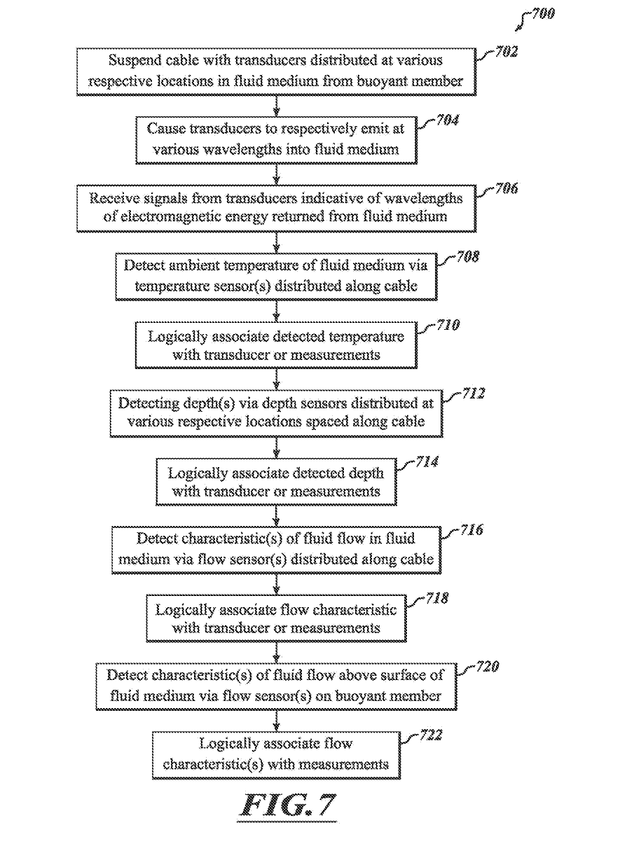

FIG. 7 shows a high level method 700 of operating an apparatus to sense characteristics of a medium, for instance a body of water using a plurality of transducers distributed along a cable, according to one illustrated embodiment.

At 702, a cable with transducers distributed at various respective locations therealong is suspended in fluid medium, for example from a buoyant member such as a buoy or a boat.

At 704, a control system of the apparatus causes a least some of the electromagnetic radiation transducers to emit electromagnetic radiation or energy at various wavelengths into fluid medium. The electromagnetic radiation or energy may be emitted according to various sequences of wavelengths and/or magnitudes. Sequences of wavelengths and/or magnitudes may be selected and varied over time to allow collection or sampling of responses from a fluid medium in response to a relatively large variety of stimuli or conditions (e.g., wavelengths) which stimuli or conditions are produced by a relatively small number of discrete emitters. Such advantageously provides the ability to uniquely identify many substances or characteristics of the medium, which may not be identifiable with smaller samplings or signatures.

At 706, the control system of the apparatus receives signals from at least some of the electromagnetic radiation transducers. At least some of the signals are indicative of electromagnetic radiation or energy returned from fluid medium in response to exposure to certain wavelengths and sense by sensors of the sets of electromagnetic radiation transducers.

Optionally at 708, a number of temperature sensors distributed at various respective locations spaced along cable sense an ambient temperature of the fluid medium at least proximate respective ones of the temperature sensors. The control system may receive signals from the temperature sensors, which signals are indicative of sensed temperature.

Optionally at 710, the controller logically associates sensed or detected temperatures with one or more of the electromagnetic radiation transducers or measurements produced by the electromagnetic radiation transducers. For example, the controller may logically associate a temperature sensed by a specific temperature sensor with the one or more electromagnetic radiation transducers closest to that temperature sensor or with electromagnetic radiation measurements produced by those one or more electromagnetic radiation transducers. The logical association may be in a record, database or other logical data structure stored in a non-transitory computer- or processor-readable storage medium. Temperatures may help characterize a condition of the fluid medium or contents of the fluid medium, or may help characterize a distribution or flow of a substance or material in the fluid medium whether itself a fluid or whether a particulate. Such may be used to provide a three dimensional mapping of a current distribution of a substance, material or condition and/or expected dispersal over time of the substance, material or condition.

Optionally at 712, one or more depth sensors distributed at various respective locations spaced along cable sense or detect depth. For example, the depth sensors may detect pressure, for instance a barometric pressure in the ambient environment at least proximate the respective depth sensor. The control system may receive signals from the depth sensors, which signals are indicative of sensed depths or pressures.

Optionally at 714, the controller logically associates sensed or detected depths with one or more of the electromagnetic radiation transducers or measurement produced by the electromagnetic radiation transducers. For example, the controller may logically associate a depth or pressure sensed by a specific depth sensor with the one or more electromagnetic radiation transducers closest to that depth sensor or with electromagnetic radiation measurements produced by those one or more electromagnetic radiation transducers. The logical association may be in a record, database or other logical data structure stored in a non-transitory computer- or processor-readable storage medium. Depths or pressures may help characterize a condition of the fluid medium or contents of the fluid medium, or may help characterize a distribution or flow of a substance or material in the fluid medium. Such may be used to provide a three dimensional mapping of a current distribution of a substance, material or condition and/or expected dispersal over time of the substance, material or condition.

Optionally, at 716, one or more flow sensors distributed at various respective locations spaced along cable may detect or sense at least one characteristic of a fluid flow in the fluid medium. For example, the flow sensors may detect or sense a direction of a fluid flow, a speed of the fluid flow and/or an acceleration of the fluid flow. The use of flow sensors distributed along the cable allows fluid flow characteristics to be detected or sensed in three dimensions.

Optionally at 718, the controller logically associates sensed or detected flow characteristics with one or more of the electromagnetic radiation transducers or measurement produced by the electromagnetic radiation transducers. For example, the controller may logically associate a flow characteristic sensed by a specific flow sensor with the one or more electromagnetic radiation transducers closest to that flow sensor or with electromagnetic radiation measurements produced by those one or more electromagnetic radiation transducers. The logical association may be in a record, database or other logical data structure stored in a non-transitory computer- or processor-readable storage medium. Flow characteristics such as direction, speed and/or acceleration may help characterize a distribution or flow of a substance or material in the fluid medium. Such may be used to provide a three dimensional mapping of a current distribution of a substance, material or condition and/or expected dispersal over time of the substance, material or condition.

Optionally at 720, one or more flow sensors carried by the apparatus may detect or sense at least one flow characteristic of a fluid flow above a surface of fluid medium. For example, one or more flow sensors may detect or sense a direction of an air flow, a speed of the air flow and/or an acceleration of the air flow.

Optionally at 722, the controller logically associates sensed or detected air flow characteristics with the electromagnetic radiation measurement produced by the electromagnetic radiation transducers. The logical association may be in a record, database or other logical data structure stored in a non-transitory computer- or processor-readable storage medium. Air flow characteristics such as direction, speed and/or acceleration may help characterize a distribution or flow of a substance or material in the fluid medium. Such may be used to provide a three dimensional mapping of expected dispersal over time of the substance, material or condition.

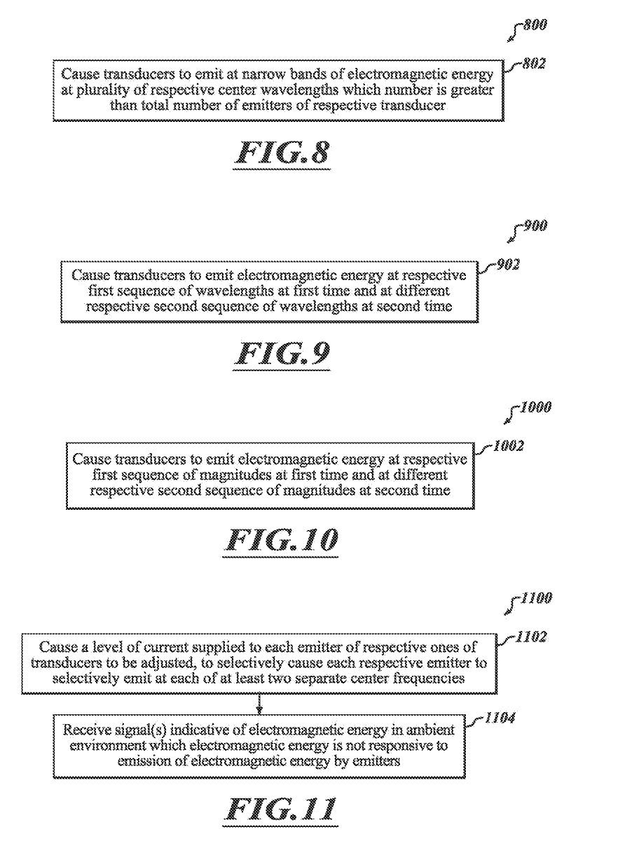

FIG. 8 shows a low level method 800 of operating a fluid medium sensor apparatus to sense characteristics of a fluid medium, for instance a body of water using a plurality of transducers distributed along a cable, according to one illustrated embodiment. The method 800 may be used in performing the method 700 (FIG. 7).

At 802, a control system of the apparatus causes at least some of a plurality of electromagnetic radiation transducers to emit narrow bands of electromagnetic radiation or energy at plurality of respective center wavelengths. The control system may cause a set of electromagnetic radiation transducers to emit at a number of center wavelengths which number is greater than a total number of physical emitters of the respective set of electromagnetic radiation transducers. Thus, the control system may operate a electromagnetic radiation transducer to implement number of virtual emitters which is greater than a total number of physical emitters of that set of electromagnetic radiation transducers. Such may, for example, be realized via control of a magnitude or level of current supplied to the emitters of the transducers.

FIG. 9 shows a low level method 900 of operating a fluid medium sensor apparatus to sense characteristics of a fluid medium, for instance a body of water using a plurality of transducers distributed along a cable, according to one illustrated embodiment. The method 900 may be used in performing the method 700 (FIG. 7).

At 902, a control system causes at least some of a plurality of sets of electromagnetic radiation transducers to emit electromagnetic radiation or energy at respective first sequence of wavelengths at a first time and at a respective second sequence of wavelengths at second time, the second sequence different than the first sequence. Such may advantageously allow collection or sampling responses to a wider variety of stimuli or conditions than might otherwise be possible with a fixed number of emitters.

FIG. 10 shows a low level method 1000 of operating a fluid medium sensor apparatus to sense characteristics of a fluid medium, for instance a body of water using a plurality of transducers distributed along a cable, according to one illustrated embodiment. The method 1000 may be used in performing the method 700 (FIG. 7).

At 1002, a control system causes at least some of a plurality of sets of electromagnetic radiation transducers to emit electromagnetic radiation or energy at respective first sequence of magnitudes at first time and at a respective second sequence of magnitudes at second time. The second sequence may be different than the first sequence.

The method 1000 may be employed concurrently with the method 900. Thus, sequences of different wavelengths and magnitudes may be employed to further increase the variety of stimuli or conditions to which the fluid medium is exposed, thereby increasing the variety or diversity of the sampling. Such variety or diversity may allow further refinement in assessing or characterizing the fluid medium, for example to detect certain conditions, substances or materials.

FIG. 11 shows a low level method 1100 of operating a fluid medium sensor apparatus to sense characteristics of a fluid medium, for instance a body of water using a plurality of sets of electromagnetic radiation transducers distributed along a cable, according to one illustrated embodiment. The method 1100 may be used in performing the method 700 (FIG. 7).

At 1102, a control system causes a level of current supplied to each emitter of respective ones of the plurality of sets of electromagnetic radiation transducers to be adjusted. Such may selectively cause each respective emitter to selectively emit at each of at least two separate center frequencies. Such may allow each single physical emitter to be operated as two or more logical or virtual emitters, each logical or virtual emitter capable of emitting at respective wavelengths and/or magnitudes.

At 1104, the control subsystem receives signals from a respective electromagnetic radiation sensor of each set of electromagnetic radiation transducers indicative of electromagnetic energy in ambient environment, which electromagnetic energy is not responsive to emission of electromagnetic energy by emitters of the sets of electromagnetic radiation transducers. For example, the controller may sample a electromagnetic radiation sensor at a time sufficiently after a most recent emission by the emitters so as to ensure that the fluid medium is no longer responding to the emission but rather is responding to ambient light. Such may provide an additional sampling of the ambient environment without any artificial stimuli or conditions.

FIG. 12 shows a low level method 1200 of operating a fluid medium sensor apparatus to sense characteristics of a fluid medium, for instance a body of water using a plurality of transducers distributed along a cable, according to one illustrated embodiment. The method 1200 may be used in performing the method 700 (FIG. 7).

At 1202, a control system wirelessly transmits information or data from a buoyant member or apparatus indicative of data collected by at least some of the electromagnetic radiation transducers. The control system may, for example, transmit information or data via a radio, for example to a remotely located facility via a satellite communications link. The information or data may include information or data in a raw form, partially or preprocessed form, or in a processed form. The information or data may include data collected by other transducers or sensors including temperatures, depths or pressures, flow characteristics of the medium and/or flow characteristics of the air above the surface of the medium. Such may facilitate remote processing of the data or information, which may include processing data or information collected by two or more apparatus, as well as by other platforms (e.g., satellite imagery, weather data).

At 1204, instructions are received at the buoyant member indicative of operational characteristics to operate electromagnetic radiation transducers. For example, the control system may receive the wireless signal via a satellite from a control system remotely located with respect to the apparatus. Satellite communications may be two-way communications. The remotely located control system may be a remotely located facility and/or may include communications from other groups or sets of apparatus. Communications other than satellite communications may be employed, for example low frequency radio communications. The instructions may, for example, include specific sequences of wavelengths and/or magnitudes for operation of the electromagnetic radiation transducers. The instructions may, for example, specify a length of the cable to be deployed or a depth at which one or more of the electromagnetic radiation transducers should be deployed. The instructions may be employed to automatically operate an automated cable feed subsystem, to automatically deploy and recover the cable. Additionally, or alternatively, the instructions may, for example, include control of various subsystems of the apparatus, for example a power subsystem or a propulsion subsystem.

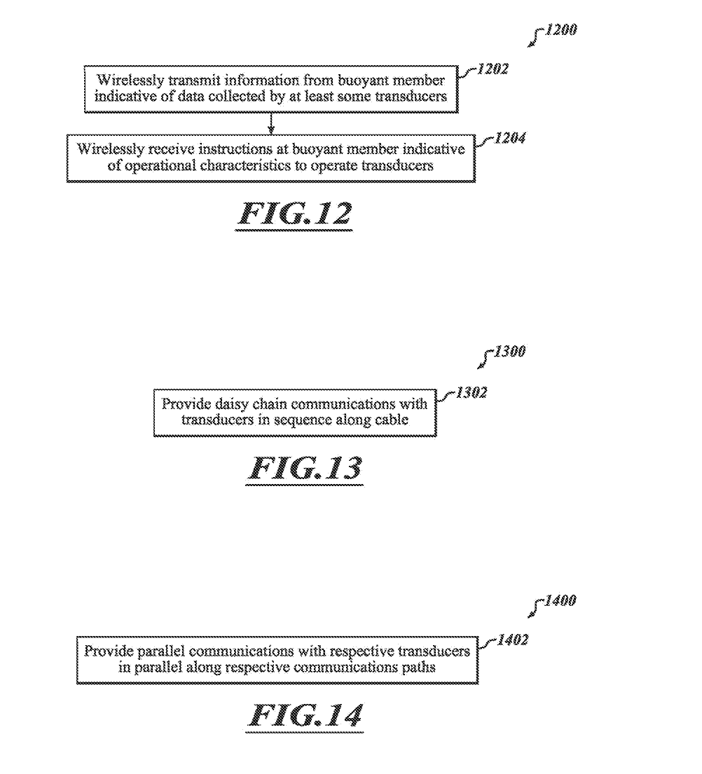

FIG. 13 shows a low level method 1300 of operating a fluid medium sensor apparatus to sense characteristics of a fluid medium, for instance a body of water using a plurality of transducers distributed along a cable, according to one illustrated embodiment. The method 1300 may be used in performing the method 700 (FIG. 7).

At 1302, a serial communications subsystem provides daisy chained communications with the plurality of electromagnetic radiation transducers in sequence along a cable. The serial communications subsystem may include a serial bus controller, a serial communications link, and transceivers at respective ones of the multispectral transducers. Such may facilitate consecutive operation of two or more multispectral transducers. Communications may likewise be provided with other transducers in addition to the electromagnetic radiation transducers.

FIG. 14 shows a low level method 1400 of operating a fluid medium sensor apparatus to sense characteristics of a fluid medium, for instance a body of water using a plurality of multispectral transducers distributed along a cable, according to one illustrated embodiment. The method 1400 may be used in performing the method 700 (FIG. 7).

At 1402, a parallel communications subsystem provides parallel communications with respective ones of a plurality of electromagnetic radiation transducers distributed along a cable. Communications may be provided along respective parallel communications paths The parallel communications subsystem may include a multiplexer or parallel communications transceiver. Such may facilitate concurrent operation of two or more multispectral transducers. Communications may likewise be provided with other transducers in addition to the electromagnetic radiation transducers.

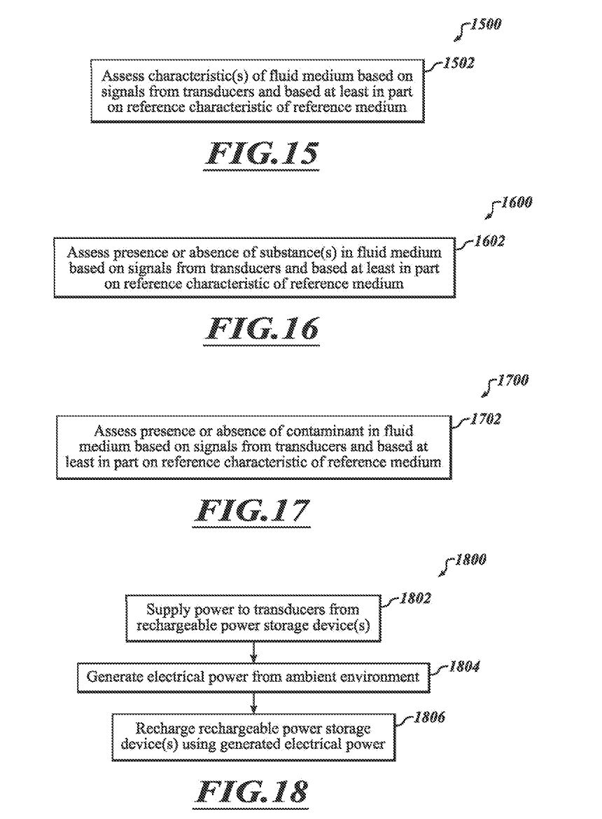

FIG. 15 shows a low level method 1500 of operating a fluid medium sensor apparatus to sense characteristics of a fluid medium, for instance a body of water using a plurality of transducers distributed along a cable, according to one illustrated embodiment. The method 1500 may be used in performing the method 700 (FIG. 7).

At 1502, a control subsystem of the apparatus assesses one or more characteristics of a fluid medium based on signals received from at least some of the plurality of electromagnetic radiation transducers and based at least in part on a number of reference characteristics of a reference medium. For example, a processor of the control subsystem may compare the sensed or detected responses to various correlated sequences of wavelength and/or magnitude of emitted electromagnetic energy to a set or representative or known responses. The processor may employ such to identify or characterize a condition (e.g., contaminants for instance petroleum, phytoplankton, red tide microorganisms, nutrients, dissolved oxygen or other gasses) of the medium. The processor may optionally use the signals from the various transducers to produce a three dimensional map of the characteristic or distribution of the characteristic in the medium.

FIG. 16 shows a low level method 1600 of operating a fluid medium sensor apparatus to sense characteristics of a fluid medium, for instance a body of water using a plurality of transducers distributed along a cable, according to one illustrated embodiment. The method 1600 may be used in performing the method 700 (FIG. 7).

At 1602, a control subsystem of the apparatus assesses a presence or absence of one or more substance(s) in a fluid medium based on signals received from at least some the plurality of transducers and based at least in part on a number of reference characteristics of a reference medium or substance. For example, a processor of the control subsystem may compare the correlated sensed or detected responses to various sequences of wavelength and/or magnitude of emitted electromagnetic energy to a set or representative or known responses. The processor may employ such to identify or characterize one or more substances (e.g., contaminants for instance petroleum, phytoplankton, red tide microorganisms, nutrients, dissolved oxygen or other gasses) in the medium. The processor may optionally use the signals from the various transducers to produce a three dimensional map of the substance(s) or distribution of the substance(s) in the medium.

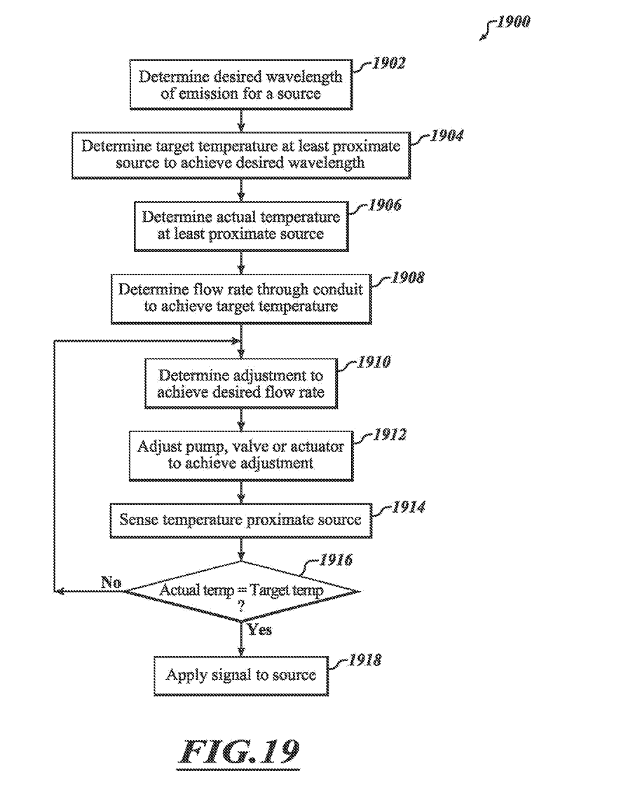

FIG. 17 shows a low level method 1700 of operating a fluid medium sensor apparatus to sense characteristics of a fluid medium, for instance a body of water using a plurality of transducers distributed along a cable, according to one illustrated embodiment. The method 1700 may be used in performing the method 700 (FIG. 7).

At 1702, a control subsystem of the apparatus assesses a presence or absence of one or more contaminants in a fluid medium based on signals received from at least some of the plurality of electromagnetic radiation transducers and based at least in part on a number of reference characteristics of a reference medium or contaminants. For example, a processor of the control subsystem may compare correlated the sensed or detected responses to various sequences of wavelength and/or magnitude of emitted electromagnetic energy to a set or representative or known responses. The processor may employ such to identify or characterize one or more contaminants (e.g., contaminants for instance petroleum, phytoplankton, red tide microorganisms, nutrients, dissolved oxygen or other gasses) in the medium. The processor may optionally use the signals from the various transducers to produce a three dimensional map of the contaminant(s) or distribution of the contaminant(s) in the medium.

FIG. 18 shows a low level method 1800 of operating a fluid medium apparatus to sense characteristics of a fluid medium, for instance a body of water using a plurality of transducers distributed along a cable, according to one illustrated embodiment. The method 1800 may be used in performing the method 700 (FIG. 7).

At 1802, one or more rechargeable power storage devices supplies electrical power at least to a plurality of electromagnetic radiation transducers distributed along a cable. The rechargeable power storage devices may also supply electrical power to a control system as well as to other transducer or sensors.

At 1804, one or more generators generate electrical power from the ambient environment. The generator(s) may take the form of a renewable power source, which may take a variety of forms including forms that convert solar, wind, wave or currents to useful power, for example electrical power. The renewable power source may, for example, produce alternating current or direct current. For example, one or more PV arrays may generate DC electrical power from solar insolation. Additionally, or alternatively, one or more turbines by generate AC electrical power from a flow of water and/or air across a propeller or impeller. The generated power may be rectified, stepped up or stepped down, or otherwise converted or conditioned. For example, one or more switch mode power converters may be employed to step up or step down a voltage of the DC electrical power. Also for example, one or more rectifiers may be employed to rectify the AC electrical power to produce DC electrical power.

At 1806, a power system recharges the one or more rechargeable power storage devices using the generated electrical power.

FIG. 19 shows a low level method 1900 of operating a fluid medium sensor apparatus to sense characteristics of a fluid medium, for instance a body of water using a plurality of multispectral transducers distributed along a cable, according to one illustrated embodiment.

At 1902, a controller determines a desired wavelength of emission for a source. A source or emitter may be capable of emitting electromagnetic radiation at two or more different wavelengths or center wavelengths depending on temperature and level of drive current. The controller may operate to cause sources or emitters to emit at a plurality of wavelengths according to some defined sequence of wavelengths. Thus, the controller may determine the desired wavelength based on an order of the defined sequence.

At 1904, the controller determines a target temperature at least proximate the source to achieved the desired wavelength of emission. As previously noted, the wavelength of emission of various sources or emitters (e.g., LEDs) may vary by temperature. Thus, a wavelength of emission may be controlled by adjusting temperature of the source or emitter. The controller may calculate the target temperature via one or more defined formulas or may determine such from a lookup table or other data structure.

At 1906, the controller determines an actual temperature at least proximate the source or emitter. The controller may rely on signals from one or more temperature sensors located at least proximate the source or emitter. Alternatively, or additionally, the controller may predict the temperature based on a level of use of the source or emitter, particularly if the source or emitter is well insulated from ambient temperature in the body of fluid being sampled other than via thermal transfer (e.g., conduction) by the fluid carried in the fluid conduit(s).

At 1908, the controller determines a flow rate of fluid through a fluid conduit to achieve the target temperature. The controller may calculate the flow rate via one or more defined thermodynamic formulas or may determine such from a lookup table or other data structure.

At 1910, the controller determines an adjustment desired to achieved the desired flow rate. Adjustment may be in an operating parameter of a pump, a valve or other actuator setting. For example, the adjustment may be in a speed or rate of the pump or in a size of opening of a valve, to achieve the desired flow rate. The controller may calculate the adjustment via one or more defined formulas or may determine such from a lookup table or other data structure.

At 1912, the controller adjusts the pump, valve or other actuator to implement the desired adjustment. For example, the controller may send signal, for example via a motor controller, to adjust a speed of a pump or the size of an opening provided by a valve.

At 1914, the controller receives temperature measurements of temperature at least proximate the source or emitter via one or more temperature sensors. Such allows the controller to determine temperature in real time or almost real time.

At 1916, the controller determines whether the actual temperature sensed is at least approximately equal to the target temperature. If the actual temperature sensed is at least approximately equal to the target temperature, the controller applies a signal (e.g., electrical current at defined current level) to the source to cause the source or emitter to emit electromagnetic radiation at the desired wavelength. Otherwise, control returns to 1910 to adjust the pump, valve or other actuator accordingly until the desired temperature is achieved or the routine times out.

While not illustrated, the apparatus may be operated to provide navigational warning signals. A signal may, for example, be transmitted from the apparatus indicative of at least a presence of the apparatus. The signal may, for instance, be a radio or microwave signal, or other wireless signal. Such may provide notification to shipping allowing avoidance of the apparatus or allowing the apparatus to be located for servicing.

While not illustrated, the apparatus may be operated to track a location of the apparatus. For example, a global location of the apparatus may be determined, for instance via one or more GPS receivers.

Some embodiments may employ the communications systems to allow tracking, for example real time tracking, of the area of data collection. Such may advantageously allow a market to be formed to pay for or subsidize the collection of data. For example, individuals or business entities may pay to collect data from a specific area of a body of water.

While generally described in terms of a buoyant member, some embodiments may omit the buoyant member, relying on a land based housing, console, or station to house the electronics. Such may, for example, be suitable for use off of piers or other structures which are not floating on the body of water. Such may also be used in a reservoir, for instance a drinking water reservoir, flooded mineshaft, or a tank such as a stationary fuel tank, mobile fuel tank (e.g., automobile, truck, airplane or other vehicle), so some other tank such as those employed in the food and beverage industries (e.g., fermenters).

Correlation generally refers to correlating a response with a particular emission or excitation. For example, where operating sources or emitters to emit a sequence of wavelengths, correlation may include associating or logically associating one or more responses with a particular wavelength which caused the response. Correlation may account for other factors or parameters, for instance a magnitude of the emission. Correlation may be achieve based on a temporal relationship, that is a response measured or otherwise detected a defined time after a given emission is correlated or associated with that given emission. More sophisticated techniques may be employed. For example, a pattern may be modulated onto the emissions, for instance a varying magnitude or intensity of emission. Correlation may include identifying the pattern in the responses and associating the responses with respective emissions based on the pattern of modulation.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other spectral based data collection systems, not necessarily the exemplary multispectral data collection systems generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of taught herein are capable of being distributed as a program product in a variety of forms, and that an illustrative embodiment applies equally regardless of the particular type of nontransitory signal bearing media used to actually carry out the distribution. Examples of nontransitory signal bearing media include, but are not limited to, the following: recordable type media such as floppy disks, hard disk drives, CD ROMs, digital tape, and computer memory.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to:

U.S. provisional patent application Ser. No. 60/820,938, filed Jul. 31, 2006; U.S. patent application Ser. No. 12/375,814, filed Jan. 30, 2009; U.S. provisional patent application Ser. No. 60/834,662, filed Jul. 31, 2006; U.S. patent application Ser. No. 11/831,662, filed Jul. 31, 2007; U.S. Provisional Patent Application No. 60/890,446, filed Feb. 16, 2007; U.S. Provisional Patent Application No. 60/883,312, filed Jan. 3, 2007; U.S. Provisional Patent Application No. 60/871,639, filed Dec. 22, 2006; U.S. Provisional Patent Application No. 60/834,589, filed Jul. 31, 2006; U.S. patent application Ser. No. 11/831,717, filed Jul. 31, 2007; and U.S. Provisional Patent Application No. 61/538, 617, filed Sep. 23, 2011, are incorporated herein by reference, in their entirety are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A sensor system to sample fluid mediums, comprising:
at least one housing;
at least one cable having a proximate portion, a distal portion and at least one sampling portion between the proximate portion and the distal portion;
a plurality of sets of transducers distributed at various respective locations spaced along at least the sampling portion of the cable, each of the sets of transducers including a plurality of emitters and at least one sensor, the plurality of emitters of each set of transducers operable to emit electromagnetic radiation at a plurality of wavelengths from the cable toward a portion of a fluid medium being sampled and the at least one sensor responsive to electromagnetic radiation returned from the portion of the fluid medium being sampled; and
at least one power storage device housed by the at least one housing and electrically coupled to provide power at least to the plurality of multispectral transducers during use.

2. The sensor system of claim 1 wherein for each set of transducers, the emitters are operable to emit a plurality of narrow bands of electromagnetic energy at a plurality of respective center wavelengths.

3. The sensor system of claim 1 wherein for each set of transducers, the emitters are operable to emit a number of narrow bands of electromagnetic energy at a plurality of respective center wavelengths which number is greater than a total number of emitters of the plurality of emitters of the respective set of transducers.

4. The sensor system of claim 1 wherein the at least one power storage device is a rechargeable power storage device housed by the at least one housing, and further comprising:
a renewable power generation system operable to generate electrical power from an ambient environment and to recharge the at least one rechargeable power storage device.

5. The sensor system of claim 1, further comprising:
a controller housed by the at least one housing and communicatively coupled to control operation of the plurality of sets of transducers.

6. The sensor system of claim 5 wherein the controller causes the plurality of emitters of a respective set of transducers to emit electromagnetic energy at a respective first sequence of wavelengths at a first time and at a respective second sequence of wavelengths at a second time, the second sequence of wavelengths different than the first sequence of wavelengths.

7. The sensor system of claim 6 wherein the controller causes the plurality of emitters of a respective set of transducers to emit electromagnetic energy at a respective first sequence of magnitudes at the first time and at a respective second sequence of magnitudes at the second time, the second sequence of magnitudes different than the first sequence of magnitudes.

8. The sensor system of claim 5 wherein the controller is configured to control a level of current supplied to at least some of the emitters of the sets of transducers, to selectively cause each respective emitter to selectively emit at each of at least two separate center frequencies.

9. The sensor system of claim 5 wherein the controller is configured to receive from the at least one sensor of at least some of the sets of transducers a signal indicative of electromagnetic energy in an ambient environment which signal is indicative of a response by the fluid medium to ambient electromagnetic energy without emission by the emitters.

10. The sensor system of claim 5 wherein the controller is configured to detect a physical characteristic of the fluid medium being sampled based on signals provided from the sensors indicative of at least one characteristic of the sampled fluid medium and at least one reference characteristic of a reference specimen.

11. The sensor system of claim 5 wherein the controller is configured to detect a presence or an absence of a substance in the fluid medium being sampled based on signals provided from the sensors indicative of at least one characteristic of a fluid medium being sampled and at least one reference characteristic of a reference specimen.

12. The sensor system of claim 5 wherein the controller is configured to detect at least one of a presence or a concentration of a contaminant in the fluid medium being sampled based on signals provided from the sensors indicative of at least one characteristic of a specimen and at least one reference characteristic of a reference specimen.

13. The sensor system of claim 1 wherein the proximate portion of the cable is a proximate end thereof and the distal portion of the cable is a distal end thereof, and further comprising:
a number of temperature sensors distributed at various respective locations spaced along at least the sampling portion of the cable, the temperature sensors responsive to an ambient water temperature proximate the respective temperature sensor.

14. The sensor system of claim 1, further comprising:
a wireless transceiver housed by the at least one housing and communicatively coupled to wirelessly transmit from the at least one housing information indicative of data collected by the sensors of the sets of transducers.

15. The sensor system of claim 1, further comprising:
at least one buoyant member that carries the at least one housing, the at least one cable physically coupleable to the buoyant member at least proximate the proximate portion of the at least one cable with the distal portion thereof spaced relatively from the buoyant member during use of the sensor system.

16. The sensor system of claim 15, further comprising:
a plurality of additional buoyant members, each of the additional buoyant members having a respective housing, a respective cable having a proximate portion, a distal portion and at least one sampling portion between the proximate portion and the distal portion; the cable physically coupleable to the respective buoyant member at least proximate the proximate portion of the at least one cable with the distal portion thereof spaced relatively from the buoyant member during use of the sensor system, a respective plurality of sets of transducers distributed at various respective locations spaced along at least the sampling portion of the cable, each of the sets of transducers including a plurality of emitters and at least one sensor, the plurality of emitters of each set of transducers operable to emit electromagnetic radiation at a plurality of wavelengths from the respective cable toward the a respective portion of the fluid medium being sampled and the at least one sensor responsive to electromagnetic radiation returned from the respective portion of the fluid medium being sampled, and a respective wireless transceiver carried by the buoyant member and communicatively coupled to wirelessly transmit from the respective buoyant member information indicative of data collected by the sensors.

17. The sensor system of claim 16 wherein the at least one buoyant member and the plurality of additional buoyant members are communicatively coupled to form a distributed sensor network.

18. The sensor system of claim 1, further comprising:
a daisy chain communications path that provides communications with each of the sets of transducers in a sequence along at least the sampling portion of the cable.

19. The sensor system of claim 1, further comprising:
a plurality of communications paths that provide communications with respective ones of the sets of transducers in parallel.

20. The sensor system of claim 1 wherein the proximate portion of the cable is a proximate end thereof and the distal portion of the cable is a distal end thereof, and further comprising:
a weight coupled at least proximate the distal end of the cable.

21. The sensor system of claim 1 wherein the proximate portion of the cable is a proximate end thereof and the distal portion of the cable is a distal end thereof, and further comprising:
a sacrificial electrode coupled to provide corrosion resistance to at least one of the cable, the at least one housing or the sets of transducers.

22. The sensor system of claim 1, further comprising:
at least one depth sensor physically attached to the cable.

23. The sensor system of claim 1, further comprising:
at least one flow sensor at least indirectly physically coupled to the at least one housing and responsive to provide signals indicative of a fluid flow.

24. The sensor system of claim 1 wherein the cable includes at least one fluid conduit extending along at least a portion of a length of the cable and having an interior that provides a path for a fluid, the at least one fluid conduit thermally coupled with at least some of the emitters of at least one of the sets of transducers to exchange heat between the fluid carried in the interior of the fluid conduit and the emitters.

25. The sensor system of claim 24 wherein at least one fluid conduit includes an opening that fluidly communicatively couples the interior of the fluid conduit with the fluid medium in which the cable is suspended.

26. The sensor system of claim 24, further comprising:
a pump coupled to cause the fluid to flow in the interior of the at least one fluid conduit, and
a controller controllingly coupled to the pump and configured to adjust a flow of the fluid in the interior of the at least one fluid conduit to control a temperature of at least one of the emitters to produce an emission of a defined wavelength.

27. A method of operating a sensor system, comprising:
causing a plurality of sets of emitters distributed at various respective locations spaced along at least a sampling portion of a cable suspended in a fluid medium, to respectively emit electromagnetic radiation at a plurality of wavelengths into the fluid medium; and
receiving signals from each of a plurality of sensors, the signals indicative of electromagnetic energy returned from the fluid medium at least proximate respective ones of the sensors in response to the emitted electromagnetic radiation.

28-49. (canceled)
